(19) United States
(12) Patent Application Publication
(10) Pub. No.: US 2025/0087919 A1
(43) Pub. Date: Mar. 13, 2025

(54) COMPACT RELIABLE ELECTRICAL CONNECTOR AND ELECTRONIC SYSTEM THEREOF

(71) Applicant: Amphenol Aorora Technology (Huizhou) Co., Ltd., Huizhou (CN)

(72) Inventors: Xiaohong Zhu, Huizhou (CN); Hancheng Chen, Huizhou (CN); Shan Huang, Huizhou (CN)

(73) Assignee: Amphenol Aorora Technology (Huizhou) Co., Ltd., Huizhou (CN)

(21) Appl. No.: 18/817,936

(22) Filed: Aug. 28, 2024

(30) Foreign Application Priority Data
Sep. 8, 2023 (CN) 202311154827.3
Jul. 24, 2024 (CN) 202421774872.9

(51) Int. Cl. H01R 12/79; H01R 13/502; H01R 13/627; H01R 13/639

(52) U.S. Cl. CPC H01R 12/79; H01R 13/502; H01R 13/6273; H01R 13/639

(57) ABSTRACT

Compact reliable connectors and electronic systems thereof are provided. An electronic system includes a receptacle connector configured for mounting on a circuit board, and a plug connector configured for mating with the receptacle connector. The plug connector includes flexible cables directly held by a housing and secured to the housing by latching members. The receptacle connector includes conductive elements disposed in rows. The conductive elements in different rows have tail ends offset in both a mating direction and a vertical direction, and mating ends offset in a longitudinal direction. Techniques described herein enable the connectors to fit in a limited space, provide reliable interconnections in a harsh environment such as one presented by an automobile, and support high voltages such as might be used in a battery management system (BMS).

### CROSS-REFERENCE TO RELATED APPLICATIONS

This application claims priority to and the benefit of Chinese Patent Application Serial No. 202421774872.9, filed on Jul. 24, 2024. This application also claims priority to and the benefit of Chinese Patent Application Serial No. 202311154827.3, filed on Sep. 8, 2023. The entire contents of these applications are incorporated herein by reference in their entirety.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted to the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of a cable assembly into a board connector that is mounted to the printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine control unit, transmission control unit (TCUs), battery management system (BMS), cell sensing circuit (CSC), security systems, emissions control system, lighting control units, advanced driver assistance systems (ADAS), entertainment systems, navigation systems, and cameras. These electronic control units may be manufactured as separate assemblies. To simplify manufacture of an automobile, the assemblies may be connected via cables that are terminated with connectors that enable connections to mating board connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high speed signals such as those use to communicate data over an automobile network.

### BRIEF SUMMARY

Aspects of the present disclosure relate to compact reliable electrical connectors and electronic systems thereof.

Some embodiments relate to a plug connector for terminating first and second flexible cables comprising a connecting end having a plurality of conductive contacts facing the plurality of conductive contacts of other one of the first and second flexible cables, the plug connector comprising a housing having a front, rear, top, bottom, and two sides each joining the top and bottom and extending from the front to the rear. The housing may comprise a top channel extending adjacent to the top and from the front through the rear, the top channel configured to receive the first flexible cable; a bottom channel extending adjacent to the bottom and from the front, the bottom channel configured to receive the second flexible cable; an accommodation space at the front, the accommodation space configured to receive portions of the first and second flexible cables having the plurality of conductive contacts; and one or more latching features configured for holding the first and second flexible cables in the top and bottom channels.

Optionally, the one or more latching features of the housing comprises: a side channel extending from the bottom towards the top; and a latching member comprising a first arm disposed in the side channel and configured to move between a pre-locked position when edges of the first and second flexible cables are offset from the first arm and a locked position when the edges of the first and second flexible cables engage the first arm such that the first and second flexible cables are fixedly disposed in the housing.

Optionally, a side of the housing comprises a first slot and a second slot disposed closer to the top than the first slot; and the latching member comprises a second arm comprising a bulge configured to be disposed in the first slot of the housing when the latching member is in the pre-locked position and in the second slot of the housing when the latching member is in the locked position.

Optionally, the latching member comprises a pair of first arms disposed on opposite sides of the accommodation space of the housing and a pair of second arms; and the pair of first arms is disposed between the pair of second arms.

Optionally, the pair of first arms are aligned with each other along a first center line; and the pair of second arms are aligned with each other along a second center line offset from the first center line in a mating direction of the plug connector.

Optionally, the housing comprises a base portion, and an accommodation portion extending from the base portion and enclosing the accommodation space; and each of the top and bottom channels comprises a portion extending at the base portion.

Optionally, for each of the first and second flexible cables, the connecting end comprises a first segment disposed in the portion of a respective one of the top and bottom channels that extends at the base portion, and a second segment extending from the first segment and having the plurality of conductive contacts.

Optionally, for each of the first and second flexible cables, the first segment comprises a notch aligned in the side channel of the housing; the one or more latching features of the housing comprises: a side channel extending from the bottom towards the top; and a latching member comprising a first arm disposed in the side channel and configured to move between a pre-locked position when edges of the first and second flexible cables are offset from the first arm and a locked position when the edges of the first and second flexible cables engage the first arm such that the first and second flexible cables are fixedly disposed in the housing; and at the locked position, the first arm of the latching member engages the notches of the first segments of the first and second flexible cables.

Optionally, for each of the first and second flexible cables, the second segment comprises a notch; and the one or more latching features of the housing comprises first and second beams extending from the base portion into the accommodation space, each of first and second beams comprising a protrusion configured to engage the notch of the second segment of a respective one of the first and second flexible cables.

Optionally, the first arm comprises an upper portion, a lower portion, and a groove between the upper and lower portions; at the pre-locked position, the upper portion of the first arm is disposed between the first and second flexible cables, and the lower portion of the first arm is disposed between the second flexible cable and the bottom of the housing; and at the locked position, the upper and lower portions of the first arm engage the edges of the first and second flexible cables, respectively.

Optionally, the top of the housing comprises a groove at the accommodation portion; and the plug connector comprises: an overhanging component having a proximal end connected to a bottom of the groove of the top at the accommodation portion and a distal end pointing to the rear, and a connector position assurance device configured to engage the overhanging component.

Optionally, the overhanging component comprises first and second beams extending between the proximal end and the distal end, and a third beam connecting the first and second beams at the distal end; the top of the housing comprises a flange portion substantially aligned with the third beam of the overhanging component; and the flange portion comprises first and second recesses towards the rear of the housing.

Optionally, the first and second flexible cables comprise a flexible flat cable (FFC), and/or a flexible circuit board (FPC).

Optionally, the front of the housing extends beyond front edges of the first and second flexible cables.

Some embodiments relate to an electronic system. The electronic system may comprise the plug connector described herein, in combination with the first and second flexible cables; a circuit board; and a receptacle connector mated with the plug connector. The receptacle connector may comprise a housing comprising a tongue portion disposed in the accommodation space of the plug connector, the tongue portion comprising a top surface and a bottom surface; a plurality of conductive elements held by the housing, each of the plurality of conductive elements comprising a mating end extending into the tongue portion of the housing, a tail end extending out of the housing and mounted on the circuit board, and an intermediate portion between the mating end and the tail end, the plurality of conductive elements comprising a plurality of first conductive elements disposed in a first row and a plurality of second conductive elements disposed in a second row, wherein: the mating ends of the plurality of first conductive elements comprises mating contact portions protruding from the top surface of the tongue portion so as to contact the plurality of conductive contacts of the first flexible cable, and the mating ends of the plurality of first conductive elements comprises mating contact portions protruding from the bottom surface of the tongue portion so as to contact the plurality of conductive contacts of the second flexible cable.

Optionally, the housing of the plug connector comprises a protrusion extending from the front of the housing in a mating direction of the plug connector, and a rib extending from the protrusion to the flange portion; and the housing of the receptacle connector comprises a recess at a front configured for receiving both the protrusion extending from the front of the housing of the plug connector and the rib extending from the protrusion to the flange portion.

Some embodiments relate to a receptacle connector. The receptacle connector may comprise a housing comprising a base portion and a tongue portion extending from the base portion in a mating direction, the tongue portion comprising a top surface and a bottom surface opposite to the top surface in a vertical direction perpendicular to the mating direction; and a plurality of conductive elements held by the housing, each of the plurality of conductive elements comprising a mating end extending into the tongue portion and having a mating contact portion, a tail end extending out of the housing, and an intermediate portion between the mating end and the tail end, the plurality of conductive elements comprising a plurality of first conductive elements having the mating contact portions protruding from the top surface of the tongue portion, and a plurality of second conductive elements having the mating contact portion protruding from the bottom surface of the tongue portion, wherein: the tail end of each of the plurality of conductive elements comprises a first segment extending from the respective intermediate portion in the mating direction, a second segment configured to mount on a circuit board, and a third segment joining the first segment and the second segment; the first segments of the tail ends of the plurality of first conductive elements and the tails ends of the plurality of second conductive elements are offset in the vertical direction; and the second segments of the tail ends of the plurality of first conductive elements and the tails ends of the plurality of second conductive elements are offset in the mating direction.

Optionally, the mating ends of the plurality of first conductive elements and the mating ends of the plurality of second conductive elements are offset in a longitudinal direction perpendicular to both the vertical direction and the mating direction.

Optionally, the base portion of the housing comprises a plurality of protrusions extending from a rear surface of the base portion; and the tail ends of the plurality of second conductive elements each extends out of a respective protrusion of the plurality of protrusions extending from the rear surface of the base portion of the housing.

Optionally, the tail ends of the plurality of first conductive elements each extends out of the rear surface of the base portion of the housing between respective adjacent protrusions of the plurality of protrusions.

Optionally, the mating end of each of the plurality of first conductive elements comprises first and second beams aligned in the vertical direction, the first beam extending beyond the second beam in the mating direction; each of the first and second beams comprises a contact portion; and the contact portions of the first and second beams are aligned in the mating direction.

Optionally, the mating end of each of the plurality of conductive elements comprises first and second beams, the first beam extending beyond the second beam in the mating direction; each of the first and second beams comprises a contact portion; the contact portions of the first and second beams are aligned in the mating direction; and the first beams of the plurality of conductive elements are disposed between respective second beams and the tongue portion of the housing.

Optionally, for each of the plurality of conductive elements, the contact portion of each of the first and second beams comprises: a first end segment having a first width in the longitudinal direction; a second end segment having a second width in the longitudinal direction, the second width less than the first width; a first transition segment joining the first end segment and the second end segment; a first leading surface adjacent a front end of the tongue portion and extending from the first end segment through the first transition segment to the second end segment; and a first trailing surface away from the front of the tongue portion and extending from the first end segment through the first transition segment to the second end segment.

Optionally, the housing comprises an accommodation portion extending from the base portion and enclosing an accommodation space open at an end opposite to the base portion; and the tongue portion is disposed in the accommodation space.

Some embodiments relate to an electronic system. The electronic system may comprise the receptacle connector described herein; and a plug connector configured to mate with the receptacle connector. The plug connector may comprise a housing comprising a base portion and an accommodation portion extending from the base portion and enclosing an accommodation space, wherein the accommodation portion of the housing of the plug connector is configured to insert into the accommodation space of the receptacle connector such that the tongue portion of the receptacle connector is disposed in the accommodation space of the plug connector; a first flexible cable held by the housing and comprising a plurality of contact pads configured to contact with the contact portions of the plurality of first conductive elements; and a second flexible cable held by the housing and comprising a plurality of contact pads configured to contact with the contact portions of the plurality of second conductive elements.

Optionally, the accommodation portion of the housing of the plug connector comprises an overhanging component; the accommodation portion of the housing of the receptacle connector comprises a recess configured for receiving at least a portion of the overhanging component of the plug connector and a bulge configured for engaging the overhanging component of the plug connector; and the electronic system comprises a connector position assurance device configured for engaging both the overhanging component of the plug connector and the recess of the accommodation portion of the housing of the receptacle connector so as to secure the plug connector to the receptacle connector.

Optionally, the housing of the plug connector comprises a flange portion configured to engage a front surface of the housing of the receptacle connector; and the flange portion of the plug connector comprises a recess away from the front surface of the housing of the receptacle connector and configured for receiving a tool to unmate the plug connector from the receptacle connector.

Some embodiments relate to an electrical connector. The electrical connector comprises: an insulative housing; a plurality of flexible cables each comprising a connecting end having a plurality of conductive contacts, the connecting ends of the plurality of flexible cables disposed in the insulative housing; and a latching member mounted to the insulative housing and configured to hold the connecting ends of the plurality of flexible cables in the insulative housing.

Optionally, the insulative housing comprises a base portion and a plurality of first channels each extending through the base portion in a lateral direction, the plurality of first channels are spaced apart from each other in a vertical direction perpendicular to the lateral direction, a first segment of the connecting end of each of the plurality of flexible cables is disposed in a corresponding one of the plurality of first channels so that the connecting ends of the plurality of flexible cables are spaced apart from each other in the vertical direction.

Optionally, for each flexible cable, the first segment has a side edge, the latching member is mounted to the base portion and is configured to move between a pre-locked position, in which the latching member does not engage with the side edges of the first segments of the plurality of flexible cables to enable the first segments to move through the first channels in the lateral direction, and a locked position, in which the latching member engages with the side edges of the first segments of the plurality of flexible cables to hold the first segments in the first channels.

Optionally, for each flexible cable, the side edge of the first segment is disposed in an end section of the corresponding first channel, the insulative housing further comprises at least one second channel each extending from the exterior of the base portion into the base portion in the vertical direction and through the end sections of the plurality of first channels, the latching member comprises at least one first arm, each first arm comprises a first body extending in the vertical direction and at least one first groove extending through the first body in the lateral direction, each of the at least one first arm is inserted in a corresponding one of the at least one second channel and is configured to be capable of moving in the corresponding second channel in the vertical direction, when the latching member is placed in the pre-locked position, each of the at least one first groove is aligned with the end sections of a corresponding one of the plurality of first channels in the lateral direction so as to enable the side edge of the corresponding first segment to move through the end section and the first groove in the lateral direction.

Optionally, for each flexible cable, the first segment comprises a notch recessed into the first segment from the side edge in a longitudinal direction perpendicular to the lateral direction and the vertical direction, the corresponding notches of the first segments of the plurality of flexible cables are aligned with each other in the vertical direction and are aligned with a corresponding one of the at least one second channel in the vertical direction, when the latching member is placed in the locked position, the at least one first groove of the first arm inserted in the corresponding second channel is moved to be offset from the end sections of the plurality of first channels in the lateral direction, and the first body of the first arm is moved into and engaged with the notches of the first segments of the plurality of flexible cables to hold the first segments in the first channels.

Optionally, the latching member further comprises a plate body and at least one second arm, each of the at least one first arm extends from the plate body in the vertical direction, each of the at least one second arm extends from the plate body in the vertical direction, and comprises a bulge, the base portion comprises at least one first slot and at least one second slot, the bulge of each of the at least one second arm is configured to be capable for being selectively snapped into a corresponding one of the at least one first slot and a corresponding one of the at least one second slot, the latching member is placed in the pre-locked position when the bulge of each second arm is snapped into the corresponding first slot, and the latching member is placed in the locked position when the bulge of each second arm is snapped into the corresponding second slot.

Optionally, the at least one first arm comprises two first arms, the two first arms each extend from a first surface of the plate body in the vertical direction and are aligned with each other in the longitudinal direction along a first center line, the at least one second arm comprises two second arms, the two second arms each extend from the first surface in the vertical direction and are aligned with each other in the longitudinal direction along a second center line, the first center line and the second center line do not overlap with each other.

Optionally, the plate body comprises a first end and a second end opposite to each other in the longitudinal direction, the at least one second arm comprises two second arms, the two second arms extend from the plate body in the vertical direction at the first end and the second end, respectively, and the bulges of the two second arms are opposite to each other in the longitudinal direction, the base portion comprises a first end face and a second end face opposite to each other in the longitudinal direction, a second groove recessed into the base portion from the first end face in the longitudinal direction, and a third groove recessed into the base portion from the second end face in the longitudinal direction, the first slot and the second slot are formed at the bottom of the second groove and the bottom of the third groove, respectively, the two second arms are received in the second groove and the third groove, respectively.

Optionally, for each flexible cable, the side edge of the first segment of the connecting end comprises a first side edge and a second side edge opposite to each other in the longitudinal direction, the first segment comprises a first notch recessed into the first segment from the first side edge in the longitudinal direction and a second notch recessed into the first segment from the second side edge in the longitudinal direction, the at least one second channel comprises two second channels, the first notches of the first segments of the plurality of flexible cables are aligned with each other in the vertical direction and are aligned with one of the two second channels in the vertical direction, the second notches of the first segments of the plurality of flexible cables are aligned with each other in the vertical direction and are aligned with the other one of the two second channels in the vertical direction, the at least one first arm comprises two first arms each disposed in a corresponding one of the two second channels.

Optionally, the insulative housing further comprises an accommodation portion extending from the base portion in the lateral direction and enclosing an accommodation space open at an end opposite to the base portion, for each flexible cable, the connecting end further comprises a second segment extending from the first segment in the lateral direction, the plurality of conductive contacts are disposed on the second segment, the second segments of the plurality of flexible cables are positioned in the accommodation space.

Optionally, for each flexible cable, the second segment comprises a side edge and a notch recessed into the second segment from the side edge in a longitudinal direction perpendicular to the lateral direction and the vertical direction, the insulative housing further comprises a plurality of beams extending from the base portion into the accommodation space in the lateral direction, each beam comprises a bulge, the bulge of each of the plurality of beams engages with the notch of the second segment of a corresponding one of the plurality of flexible cables to hold the second segment in the accommodation space.

Optionally, the plurality of flexible cables comprise a first flexible cable and a second flexible cable, the second segment of the first flexible cable and the second segment of the second flexible cable are adjacent to each other and spaced apart from each other in the vertical direction, and the plurality of conductive contacts of the first flexible cable and the plurality of conductive contacts of the second flexible cable are opposite to each other and spaced apart from each other in the vertical direction, a first group of the plurality of beams extend from the base portion in the lateral direction and between the second segment of the first flexible cable and the second segment of the second flexible cable and engage with the notches of the second segment of the first flexible cable, a second group of the plurality of beams extend from the base portion in the lateral direction and between the second segment of the first flexible cable and the second segment of the second flexible cable and engage with the notches of the second segment of the second flexible cable.

Optionally, each of the plurality of beams comprises a third body, and the bulge protrudes from the third body in the vertical direction, the accommodation portion comprises a first wall and a second wall opposite to each other and spaced apart from each other in the vertical direction, the first wall and the third bodies of the beams of the first group clamp the side edges of the second segment of the first flexible cable therebetween, the second wall and the third bodies of the beams of the second group clamp the side edges of the second segment of the second flexible cable therebetween.

Optionally, the second segment of the first flexible cable comprises a first side edge and a second side edge opposite to each other in the longitudinal direction, a first notch recessed into the second segment from the first side edge in the longitudinal direction, and a second notch recessed into the second segment from the second side edge in the longitudinal direction, the first group comprises two beams, the bulges of the two beams engage with the first notch and the second notch of the second segment of the first flexible cable, respectively, to hold the second segment in the accommodation space.

Optionally, the second segment of the second flexible cable comprises a third side edge and a fourth side edge opposite to each other in the longitudinal direction, a third notch recessed into the second segment from the third side edge in the longitudinal direction, and a fourth notch recessed into the second segment from the fourth side edge in the longitudinal direction, the second group comprises two beams, the bulges of the two beams engage with the third notch and the fourth notch of the second segment of the second flexible cable, respectively, to hold the second segment in the accommodation space.

Optionally, the second segment of the first flexible cable comprises a first side edge and a second side edge opposite to each other in the longitudinal direction, a profile of the first side edge and a profile of the second side edge are asymmetric about a center line of the second segment.

Optionally, the second segment of the second flexible cable comprises a third side edge and a fourth side edge opposite to each other in the longitudinal direction, a profile of the third side edge and a profile of the fourth side edge are asymmetric about a center line of the second segment.

Optionally, the first segment of the first flexible cable and the first segment of the second flexible cable each comprise two side edges opposite to each other in the longitudinal direction, the first segment of the first flexible cable and the first segment of the second flexible cable are parallel with each other and bound a midplane therebetween, the two side edges of the first segment of the first flexible cable bound a first outer profile of the first flexible cable, the two side edges of the first segment of the second flexible cable bound a second outer profile of the second flexible cable, the first outer profile and the second outer profile are asymmetric about the midplane.

Optionally, the accommodation portion comprises a first wall and a second wall opposite to each other and spaced apart from each other in the vertical direction, and a third wall and a fourth wall opposite to each other and spaced apart from each other in a longitudinal direction perpendicular to the lateral direction and the vertical direction, the first wall, the second wall, the third wall, and the fourth wall enclose the accommodation space, the accommodation portion is configured to be inserted into a housing of a second electrical connector for mating with the electrical connector, the first wall and the third wall are connected with each other at a first corner, and the first wall and the fourth wall are connected with each other at a second corner, the accommodation portion further comprises a first rib protruding outwardly from the first wall in the vertical direction at the first corner, and a second rib protruding outwardly from the first wall in the vertical direction at the second corner, the first rib and the second rib extend in the lateral direction, respectively.

Optionally, the accommodation portion comprises a first wall and a second wall opposite to each other and spaced apart from each other in the vertical direction, and a third wall and a fourth wall opposite to each other and spaced apart from each other in a longitudinal direction perpendicular to the lateral direction and the vertical direction, the first wall, the second wall, the third wall, and the fourth wall enclose the accommodation space, the accommodation portion is configured to be inserted into a housing of a second electrical connector for mating with the electrical connector, the third wall extends beyond the first wall and the second wall in the lateral direction to form a first protrusion, the fourth wall extends beyond the first wall and the second wall in the lateral direction to form a second protrusion.

Optionally, the accommodation portion comprises: a first wall and a second wall opposite to each other and spaced apart from each other in the vertical direction; a groove recessed into the first wall from an outer surface of the first wall in the vertical direction and extending in the lateral direction, the groove comprising a bottom wall and a first sidewall and a second sidewall opposite to each other in a longitudinal direction perpendicular to the lateral direction and the vertical direction; and an overhanging component, comprising: a first resilient beam and a second resilient beam each extending from the bottom wall towards the base portion in the lateral direction, the first resilient beam and the second resilient beam each comprising a first end and a second end opposite to each other in the lateral direction, the first end connected to the bottom wall, the second end configured to be unfixed and spaced apart from the bottom wall in the vertical direction, the first resilient beam and the second resilient beam spaced apart from each other in the longitudinal direction and defining a receiving space therebetween; a third beam extending from the second end of the first resilient beam to the second end of the second resilient beam in the longitudinal direction; and a fourth beam extending in the longitudinal direction and comprising a third end and a fourth end opposite to each other in the longitudinal direction, the third end connected to the first resilient beam between the first end and the second end of the first resilient beam, and the fourth end connected to the second resilient beam between the first end and the second end of the second resilient beam, the fourth beam configured to engage with a mating bulge of a second electrical connector when the electrical connector is mated with the second electrical connector.

Optionally, the latching member is a first latching member, the electrical connector further comprises a second latching member disposed in the groove, the second latching member comprises: a base body; a first resilient arm and a second resilient arm extending from the base body in the lateral direction, respectively, the first resilient arm and the second resilient arm are opposite to each other and spaced apart from each other in the longitudinal direction and engage with the first sidewall and the second sidewall of the groove, respectively, to hold the second latching member in the groove, the first resilient arm and the second resilient arm each comprise a first protrusion protruding in the vertical direction; and a third resilient arm extending obliquely from the base body in the lateral direction into the receiving space and having a second protrusion at an end opposite to the base body, wherein the second latching member is configured to be capable of being moved in the groove in the lateral direction between a first position and a second position relative to the overhanging component, wherein: when the second latching member is placed in the first position, the first protrusion of the first resilient arm and the first protrusion of the second resilient arm engage with the first resilient beam and the second resilient beam below the first resilient beam and the second resilient beam, respectively, and the second protrusion of the third resilient arm is positioned to engage with the fourth beam at a side of the fourth beam opposite to the third beam, thereby locking the overhanging component to prevent the third beam and the fourth beam from moving towards the bottom wall when biased towards the bottom wall; and when the second latching member is placed in the second position, the first protrusion of the first resilient arm and the first protrusion of the second resilient arm do not engage with the first resilient beam and the second resilient beam below the first resilient beam and the second resilient beam, and the second protrusion of the third resilient arm is positioned between the fourth beam and the third beam, thereby unlocking the overhanging component to enable the third beam and the fourth beam to move towards the bottom wall when biased towards the bottom wall.

Optionally, the plurality of flexible cables comprise a flexible flat cable (FFC), a flexible circuit board (FPC) or a combination thereof.

Some embodiments relate to an electrical connector. The electrical connector comprises: an insulative housing comprising a base portion and a tongue portion extending from the base portion in a lateral direction, the tongue portion comprising a first surface and a second surface opposite to each other in a vertical direction perpendicular to the lateral direction; and a plurality of conductive elements disposed in the insulative housing, each conductive element comprising a mating end having a mating contact portion, a tail end opposite to the mating end, and an intermediate portion joining the mating end and the tail end. The plurality of conductive elements comprises: a plurality of first conductive elements arranged in a first row in a longitudinal direction perpendicular to the lateral direction and the vertical direction, and the mating ends of the plurality of first conductive elements extending into the tongue portion with the mating contact portions thereof protruding from the first surface; and a plurality of second conductive elements arranged in a second row in the longitudinal direction, and the mating ends of the plurality of second conductive elements extending into the tongue portion with the mating contact portions thereof protruding from the second surface. The mating ends of the plurality of first conductive elements and the mating ends of the plurality of second conductive elements are offset from each other in the vertical direction.

Optionally, the base portion comprises a third surface and a fourth surface at a side opposite to the tongue portion, the third surface and the fourth surface are perpendicular to the lateral direction and face towards the same direction, the fourth surface is farther away from the tongue portion in the lateral direction than the third surface, the tail ends of the plurality of first conductive elements extend out from the third surface of the base portion in the lateral direction, the tail ends of the plurality of second conductive elements extend out from the fourth surface of the base portion in the lateral direction.

Optionally, the base portion comprises a plurality of protrusions protruding from the third surface in the lateral direction, aligned with each other and spaced apart from each other in the longitudinal direction, each protrusion comprises a rear face parallel to the third surface and facing towards the same direction as the third surface, the rear faces of the plurality of protrusions are coplanar, the fourth surface of the base portion comprises the rear faces of the plurality of protrusions, the tail end of each of the plurality of second conductive elements extends from the rear face of a corresponding one of the plurality of protrusions of the base portion in the lateral direction.

Optionally, the electrical connector is configured to be mounted on a circuit board, the base portion comprises a top surface and a bottom surface opposite to each other in the vertical direction, the bottom surface faces towards a surface of the circuit board when the electrical connector is mounted on the circuit board, the second surface of the tongue portion is closer to the bottom surface of the base portion in the vertical direction than the first surface, for the plurality of conductive elements, the tail end of each conductive element comprises a first segment extending from the intermediate portion and out of the base portion in the lateral direction, a second segment configured to be mounted to the circuit board, and a third segment joining the first segment and the second segment, the third segment extends from the first segment towards a plane defined by the bottom surface of the base portion, every adjacent two of the plurality of protrusions bound a gap therebetween in the longitudinal direction, the third segment of each of the plurality of first conductive elements extends through the gap between two corresponding adjacent protrusions in the vertical direction so that the third segments of every two adjacent first conductive elements are separated by the protrusion.

Optionally, the first segment and the third segment of the first conductive element do not extend beyond the rear face of the protrusion in the lateral direction.

Optionally, for the plurality of conductive elements, the second segment of the tail end of each conductive element is configured to be mounted to a conductive pad of the circuit board, mounting surfaces of the second segments of the tail ends of the plurality of conductive elements are coplanar in a plane perpendicular to the vertical direction, the second segments of the plurality of first conductive elements are closer to the third surface than the second segments of the plurality of second conductive elements, the second segments of the plurality of first conductive elements and the second segments of the plurality of second conductive elements are offset from each other in the lateral direction.

Optionally, the intermediate portions of the plurality of first conductive elements and the intermediate portions of the plurality of second conductive elements are disposed in the base portion and are offset from each other in the vertical direction.

Some embodiments relate to an electrical connector. The electrical connector comprises: an insulative housing comprising a base portion and a tongue portion extending from the base portion in a lateral direction, the base portion comprising a third surface and a fourth surface at a side opposite to the tongue portion, the third surface and the fourth surface perpendicular to the lateral direction and facing towards the same direction, the fourth surface farther from the tongue portion in the lateral direction than the third surface; and a plurality of conductive elements disposed in the insulative housing, each conductive element comprising a mating end having a mating contact portion, a tail end opposite to the mating end, and an intermediate portion joining the mating end and the tail end. The plurality of conductive elements comprises: a plurality of first conductive elements, the plurality of first conductive elements arranged in a first row in a longitudinal direction perpendicular to the lateral direction, and the tail ends of the plurality of first conductive elements extending out from the third surface of the base portion in the lateral direction, and a plurality of second conductive elements, the plurality of second conductive elements arranged in a second row in the longitudinal direction, and the tail ends of the plurality of second conductive elements extending out from the fourth surface of the base portion in the lateral direction.

Optionally, the base portion comprises a plurality of protrusions protruding from the third surface in the lateral direction, the plurality of protrusions are aligned with each other and spaced apart from each other in the longitudinal direction, each protrusion comprises a rear face parallel to the third surface and facing towards the same direction as the third surface, the rear faces of the plurality of protrusions are coplanar, the fourth surface of the base portion comprises the rear faces of the plurality of protrusions, the tail end of each of the plurality of second conductive elements extends out from the rear face of a corresponding one of the plurality of protrusions of the base portion in the lateral direction.

Optionally, the electrical connector is configured to be mounted on a circuit board, the base portion comprises a top surface and a bottom surface opposite to each other in a vertical direction perpendicular to the lateral direction and the longitudinal direction, the bottom surface faces towards a surface of the circuit board when the electrical connector is mounted on the circuit board, for the plurality of conductive elements, the tail end of each conductive element comprises a first segment extending from the intermediate portion and out from the base portion in the lateral direction, a second segment configured to be mounted to the circuit board, and a third segment joining the first segment and the second segment, the third segment extends from the first segment towards a plane defined by the bottom surface of the base portion, every adjacent two of the plurality of protrusions bound a gap therebetween in the longitudinal direction, at least a portion of the third segment of each of the plurality of first conductive elements extends through the gap between two corresponding adjacent protrusions in the vertical direction so that at least the portions of the third segments of every two adjacent first conductive elements are separated by the protrusion.

Optionally, the intermediate portions of the plurality of first conductive elements and the intermediate portions of the plurality of second conductive elements are disposed in the base portion, and the intermediate portion of each of the plurality of first conductive elements and the intermediate portion of a corresponding one of the plurality of second conductive elements are aligned with each other in the vertical direction, each of the plurality of protrusions has a side face facing away from a plane defined by the bottom surface of the base portion, for the plurality of first conductive elements, the third segment of each first conductive element comprises a first segment extending from the first segment in the longitudinal direction, and a second segment extending from the first segment to the second segment in the vertical direction, the first segment of the first conductive element extends out from the third surface of the base portion in the longitudinal direction above the side face of a corresponding one of the plurality of protrusions, the first segment of the third segment extends along the side face in the longitudinal direction, and the second segment extends through the gap between two corresponding adjacent protrusions in the vertical direction.

Optionally, the first segment and the third segment of the first conductive element do not extend beyond the rear face of the protrusion in the lateral direction.

Optionally, for the plurality of conductive elements, the second segment of the tail end of each conductive element is configured to be mounted to a conductive pad of the circuit board, mounting surfaces of the second segments of the tail ends of the plurality of conductive elements are coplanar in a plane perpendicular to the vertical direction, the second segments of the plurality of first conductive elements are closer to the third surface than the second segments of the plurality of second conductive elements, the second segments of the plurality of first conductive elements and the second segments of the plurality of second conductive elements are offset from each other in the lateral direction.

Optionally, the tongue portion comprises a first surface and a second surface opposite to each other in a vertical direction perpendicular to the lateral direction and the longitudinal direction, the mating ends of the plurality of first conductive elements extend into the tongue portion with the mating contact portions thereof protruding from the first surface, and the mating ends of the plurality of second conductive elements extend into the tongue portion with the mating contact portions protruding from the second surface, the mating end of each of the plurality of first conductive elements and the mating end of a corresponding one of the plurality of second conductive elements are aligned with each other in the vertical direction.

Optionally, for each first conductive element, the mating end comprises a first beam and a second beam extending from the intermediate portion in the lateral direction in a first plane perpendicular to the longitudinal direction and spaced apart from each other in the vertical direction, the first beam and the second beam each have a contact portion, the first beam is longer in the lateral direction than the second beam so that the contact portion of the first beam and the contact portion of the second beam protrude from the first surface and are aligned with each other and spaced apart from each other in the lateral direction and so that the contact portion of the first beam is closer to a front end of the tongue portion opposite to the base portion than the contact portion of the second beam.

Optionally, for the first beam of each first conductive element, the first beam comprises a first end and a second end opposite to each other, and a first straight segment joining the first end and the second end, the first end is connected to the intermediate portion and the second end is configured to be unfixed, the first straight segment extends obliquely from the first end relative to the lateral direction towards the second beam to the second end, the contact portion is located at the second end and protrudes from the first straight segment in the vertical direction.

Optionally, for the second beam of each first conductive element, the second beam comprises a third end and a fourth end opposite to each other, a curved segment extending from the third end, and a second straight segment joining the curved segment and the fourth end, the third end is connected to the intermediate portion and the fourth end is configured to be unfixed, the curved segment is curved from the third end towards the first beam so that the second straight segment and the fourth end are located between the intermediate portion and the second end of the first beam of the first conductive element in the lateral direction, the second straight segment extends from the curved segment to the fourth end, the contact portion is located at the fourth end and protrudes from the second straight segment in the vertical direction.

Optionally, for each first conductive element, the contact portion of the first beam has a convex shape and comprises a first leading surface adjacent to the front end of the tongue portion in the lateral direction and a first trailing surface away from the front end of the tongue portion in the lateral direction, wherein the first leading surface is formed as an inclined guiding surface and/or the first trailing surface is formed as an inclined guiding surface.

Optionally, the contact portion of the second beam has a convex shape and comprises a second leading surface adjacent to the front end of the tongue portion in the lateral direction and a second trailing surface away from the front end of the tongue portion in the lateral direction, wherein the second leading surface is formed as an inclined guiding surface and/or the second trailing surface is formed as an inclined guiding surface.

Optionally, the contact portion of the first beam has a convex shape and comprises a first end segment and a second end segment opposite to each other in the vertical direction, and a first transition segment joining the first end segment and the second end segment, the first end segment is connected to the second end of the first beam and has a constant first width in the longitudinal direction, the second end segment has a constant second width in the longitudinal direction, the second width is less than the first width, a cross section of the first transition segment perpendicular to the lateral direction has an isosceles trapezoidal shape, and the first transition segment has a width in the longitudinal direction tapering from the first width to the second width.

Optionally, the contact portion of the second beam has a convex shape and comprises a third end segment and a fourth end segment opposite to each other in the vertical direction, and a second transition segment joining the third end segment and the fourth end segment, the third end segment is connected to the fourth end of the second beam and has a constant third width in the longitudinal direction, the fourth end segment has a constant fourth width in the longitudinal direction, the fourth width is less than the third width, a cross section of the second transition segment perpendicular to the lateral direction has an isosceles trapezoidal shape, and the second transition segment has a width in the longitudinal direction tapering from the third width to the fourth width.

Optionally, the first beam and the second beam are flexible beams.

Optionally, the contact portion of the first beam and the contact portion of the second beam together constitute the mating contact portion of the mating end of the first conductive element.

Optionally, for each second conductive element, the mating end comprises a third beam and a fourth beam extending from the intermediate portion in the lateral direction in a second plane perpendicular to the longitudinal direction and spaced apart from each other in the vertical direction, the third beam and the fourth beam each have a contact portion, the third beam is longer in the lateral direction than the fourth beam so that the contact portion of the third beam and the contact portion of the fourth beam protrude from the second surface and are aligned with each other and spaced apart from each other in the lateral direction, and so that the contact portion of the third beam is closer to the front end of the tongue portion than the contact portion of the fourth beam.

Optionally, the insulative housing further comprises an accommodation portion extending from the base portion in the lateral direction and enclosing an accommodation space open at an end opposite to the base portion, the tongue portion is positioned in the accommodation space.

Optionally, the accommodation portion comprises a first wall and a second wall opposite to each other and spaced apart from each other in a vertical direction perpendicular to the horizontal direction and the longitudinal direction, and a third wall and a fourth wall opposite to each other and spaced apart from each other in the longitudinal direction, the first wall, the second wall, the third wall, and the fourth wall enclose the accommodation space, the accommodation portion is configured to receive a housing of a second electrical connector for mating with the electrical connector, the first wall and the third wall are connected to each other at a first corner, and the first wall and the fourth wall are connected to each other at a second corner, the accommodation portion further comprises a first groove recessed from the accommodation space into the first wall in the vertical direction at the first corner, and a second groove recessed from the accommodation space into the first wall in the vertical direction at the second corner, the first groove and the second groove extend in the lateral direction, respectively.

Some embodiments relate to a connector assembly. The connector assembly comprises a first electrical connector and a second electrical connector mated with the first electrical connector. The first electrical connector, comprises: an insulative first housing; and a first flexible cable and a second flexible cable each comprising a connecting end having a plurality of conductive contacts, the connecting end of the first flexible cable and the connecting end of the second flexible cable disposed in the first housing and spaced apart from each other in a vertical direction, so that the plurality of conductive contacts of the first flexible cable and the plurality of conductive contacts of the second flexible cable are opposite to each other and spaced apart from each other in the vertical direction. The second electrical connector comprises: an insulative second housing comprising a tongue portion including a first surface and a second surface opposite to each other in the vertical direction; and a plurality of conductive elements each comprising a mating end having a mating contact portion, the plurality of conductive elements disposed in the second housing with the mating contact portions of the mating ends protruding from the first surface and the second surface. The tongue portion of the second electrical connector is received in the first housing of the first electrical connector and is positioned between the connecting end of the first flexible cable and the connecting end of the second flexible cable so that the mating contact portions of the mating ends of the plurality of conductive elements electrically contact with the plurality of conductive contacts of the first flexible cable and the plurality of conductive contacts of the second flexible cable.

Optionally, for each of the first flexible cable and the second flexible cable, the connecting end comprises a first segment and a second segment extending from the first segment in a lateral direction perpendicular to the vertical direction, the plurality of conductive contacts are disposed on the second segment, the first housing comprises a first base portion and a first accommodation portion extending from the first base portion in the lateral direction and enclosing a first accommodation space open at an end opposite to the first base portion, the first segment of the first flexible cable and the first segment of the second flexible cable are held in the first base portion, the second segment of the first flexible cable and the second segment of the second flexible cable are positioned in the first accommodation space and spaced apart from each other in the vertical direction so that the plurality of conductive contacts of the first flexible cable and the plurality of conductive contacts of the second flexible cable are opposite to each other and spaced apart from each other in the vertical direction, the tongue portion of the second electrical connector is received in the first accommodation space of the first electrical connector and is positioned between the second segment of the first flexible cable and the second segment of the second flexible cable.

Optionally, the second housing comprises a second base portion and a second accommodation portion, the tongue portion and the second accommodation portion extend from the second base portion in the lateral direction, respectively, the second accommodation portion encloses a second accommodation space open at an end opposite to the second base portion and the tongue portion is positioned in the second accommodation space, the first accommodation portion of the first housing is received in the second accommodation portion of the second housing and is positioned between the tongue portion and the second accommodation portion of the second housing.

Optionally, the first accommodation portion of the first housing comprises a first wall and a second wall opposite to each other and spaced apart from each other in the vertical direction, and a third wall and a fourth wall opposite to each other and spaced apart from each other in a longitudinal direction perpendicular to the lateral direction and the vertical direction, the first wall, the second wall, the third wall, and the fourth wall enclose the first accommodation space, the first wall and the third wall are connected to each other at a first corner, and the first wall and the fourth wall are connected to each other at a second corner, the second accommodation portion of the second housing comprises a fifth wall and a sixth wall opposite to each other and spaced apart from each other in the vertical direction, and a seventh wall and an eighth wall opposite to each other and spaced apart from each other in the longitudinal direction, the fifth wall, the sixth wall, the seventh wall, and the eighth wall enclose the second accommodation space, the fifth wall and the seventh wall are connected to each other at a third corner, and the fifth wall and the eighth wall are connected to each other at a fourth corner, the first wall and the second segment of the first flexible cable are received between the fifth wall and the tongue portion, the second wall and the second segment of the second flexible cable are received between the sixth wall and the tongue portion, the third wall is received between the seventh wall and the tongue portion, and the fourth wall is received between the eighth wall and the tongue portion.

Optionally, the first accommodation portion of the first housing further comprises a first rib protruding outwardly from the first wall in the vertical direction at the first corner, and a second rib protruding outwardly from the first wall in the vertical direction at the second corner, the first rib and the second rib extend in the lateral direction, respectively, the second accommodation portion of the second housing further comprises a first groove recessed from the second accommodation space into the fifth wall in the vertical direction at the third corner, and a second groove recessed from the second accommodation space into the fifth wall in the vertical direction at the fourth corner, the first groove and the second groove extend in the lateral direction, respectively, the first rib and the second rib are received in the first groove and the second groove, respectively.

Optionally, the third wall extends beyond the first wall and the second wall in the lateral direction to form a first protrusion, and the fourth wall extends beyond the first wall and the second wall in the lateral direction to form a second protrusion, the tongue portion and the second accommodation portion extend from a third surface of the second base portion in the lateral direction, respectively, the second housing further comprises a first recess and a second recess recessed into the third surface of the second base portion from the second accommodation space in the lateral direction at opposite ends of the tongue portion in the longitudinal direction, respectively, the first protrusion and the second protrusion are received in the first recess and the second recess, respectively.

Optionally, the first accommodation portion of the first housing comprises: a third groove recessed into the first wall in the vertical direction from an outer surface of the first wall and extending in the lateral direction, the third groove comprises a bottom wall and a first sidewall and a second sidewall opposite to each other in the longitudinal direction; and an overhanging component comprising: a first resilient beam and a second resilient beam each extending from the bottom wall in the lateral direction towards the base portion, the first resilient beam and the second resilient beam each comprise a first end and a second end opposite to each other in the lateral direction, the first end is connected to the bottom wall, the second end is configured to be unfixed and spaced apart from the bottom wall in the vertical direction, the first resilient beam and the second resilient beam are spaced apart from each other in the longitudinal direction and bound a receiving space therebetween; a third beam extending from the second end of the first resilient beam to the second end of the second resilient beam in the longitudinal direction; and a fourth beam extending in the longitudinal direction and comprising a third end and a fourth end opposite to each other in the longitudinal direction, the third end is connected to the first resilient beam between the first end and the second end of the first resilient beam, and the fourth end is connected to the second resilient beam between the first end and the second end of the second resilient beam; the second accommodation portion of the second housing comprises: a fourth groove recessed from the second accommodation space into the fifth wall in the vertical direction and extending in the lateral direction, the fourth groove comprises a bottom wall; and a bulge protruding from the bottom wall of the fourth groove into the fourth groove; wherein the first resilient beam and the second resilient beam extend into the fourth groove so that the fourth beam is positioned in the fourth groove and the bulge is positioned between the fourth beam and the third beam and engages with the fourth beam.

Optionally, the first electrical connector further comprises a latching member disposed in the third groove, the latching member comprises: a base body; a first resilient arm and a second resilient arm extending from the base body in the lateral direction, respectively, the first resilient arm and the second resilient arm opposite to each other and spaced apart from each other in the longitudinal direction and engaging with the first sidewall and the second sidewall of the third groove, respectively, to retain the latching member in the third groove, the first resilient arm and the second resilient arm each comprising a first protrusion protruding in the vertical direction; and a third resilient arm extending obliquely from the base body in the lateral direction into the receiving space and having a second protrusion at an end opposite to the base body; wherein the latching member is configured to be capable of being moved between a first position and a second position in the third groove in the lateral direction relative to the overhanging component, wherein: when the latching member is placed in the first position, the first protrusion of the first resilient arm and the first protrusion of the second resilient arm engage with the first resilient beam and the second resilient beam below the first resilient beam and the second resilient beam, respectively, and the second protrusion of the third resilient arm is positioned to engage with the fourth beam at a side of the fourth beam opposite to the third beam, thereby locking the overhanging component to prevent the third beam and the fourth beam from moving towards the bottom wall when biased towards the bottom wall; and when the latching member is placed in the second position, the first protrusion of the first resilient arm and the first protrusion of the second resilient arm do not engage with the first resilient beam and the second resilient beam below the first resilient beam and the second resilient beam, and the second protrusion of the third resilient arm is positioned between the fourth beam and the third beam, thereby unlocking the overhanging component to enable the third beam and the fourth beam to move towards the bottom wall when biased towards the bottom wall.

Optionally, the second accommodation portion of the second housing further comprises a reinforce rib protruding from the bottom wall of the fourth groove into the fourth groove and extending in the lateral direction; the fourth beam of the overhanging component comprises a first notch extending through the fourth beam in the lateral direction; the second protrusion of the third resilient arm of the latching member comprises a second notch extending through the second protrusion in the lateral direction; and when the latching member is placed in the second position, the first notch and the second notch are aligned with each other in the lateral direction, and the reinforce rib extends through the first notch and the second notch in the lateral direction.

Optionally, the first electrical connector is configured to be capable of being manipulated by a tool, when the latching member is placed in the second position, to un-mate from the second electrical connector, wherein: the first housing comprises a flange portion protruding outwardly from the first base portion in the vertical direction and abutting against a front edge of the fifth wall of the second accommodation portion in the lateral direction, the flange portion comprises a first side facing towards the front edge, and a first receiving recess and a second receiving recess recessed into the flange portion from the first side in the lateral direction; and the tool comprises a tool body and a first leg, a second leg, and a third leg extending from the tool body, the third leg is located between the first leg and the second leg, the first leg and the second leg of the tool are capable of being received in the first receiving recess and the second receiving recess, respectively, to enable the third leg to align with the third beam in the vertical direction and to bias the third beam towards the bottom wall, so as to cause the fourth beam to move towards the bottom wall to disengage from the bulge, and by deflecting the tool away from the base portion, the first leg and the second leg can pry the first accommodation portion of the first housing with the front edge of the fifth wall as a fulcrum to cause the first accommodation portion to be move away from the second accommodation portion in the lateral direction.

Optionally, the second electrical connector is configured to be mounted on a circuit board.

Optionally, the first flexible cable and the second flexible cable of the first electrical connector comprise a flexible flat cable (FFC), a flexible circuit board (FPC), or a combination thereof.

These techniques may be used alone or in any suitable combination. The foregoing summaries are provided by way of illustration and are not intended to be limiting.

### BRIEF DESCRIPTION OF DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1A is a perspective view of an electronic system, showing a first electrical connector (e.g., a plug connector) mated with a second electrical connector (e.g., a receptacle connector) mounted on a circuit board, according to some embodiments;

FIG. 1B is another perspective view of the electronic system of FIG. 1A;

FIG. 1C is a perspective view of the electronic system of FIG. 1A, showing tail ends of conductive elements of the second electrical connector connected to the circuit board;

FIG. 2 is a cross-sectional view of the electronic system of FIG. 1A along the line I-I in FIG. 1A;

FIG. 3A is a cross-sectional view of the electronic system of FIG. 1A along the line II-II in FIG. 2;

FIG. 3B is a cross-sectional view of the electronic system of FIG. 1A along the line III-III in FIG. 2;

FIG. 4A is a perspective view of the first electrical connector of FIG. 1A;

FIG. 4B is an exploded perspective view of the first electrical connector of FIG. 4A, showing an insulative housing, a first flexible cable, a second flexible cable, a first latching member, and a second latching member, with a first side of the first flexible cable shown;

FIG. 4C is a front view of the first electrical connector of FIG. 4A;

FIG. 4D is a top view of the first electrical connector of FIG. 4A;

FIG. 4E is a perspective view of the first flexible cable, showing a second side of the first flexible cable opposite to the first side;

FIG. 4F is a perspective view of another embodiment of the first electrical connector of FIG. 1A;

FIG. 5A is a perspective view of the first latching member of the first electrical connector of FIG. 4A;

FIG. 5B is a front view of the first latching member of FIG. 5A;

FIG. 5C is a top view of the first latching member of FIG. 5A;

FIG. 6A is a cross-sectional view of the first electrical connector of FIG. 4A or 4F along the line VII-VII in FIG. 4D, showing the first latching member placed in a pre-locked position and the first flexible cable and the second flexible cable disposed in the insulative housing;

FIG. 6B is a cross-sectional view similar to FIG. 6A, showing the first latching member placed in a locked position and the first flexible cable and the second flexible cable locked in the insulative housing;

FIG. 6C is an enlarged view of the region 6C of FIG. 6A;

FIG. 6D is an enlarged view of the region 6D of FIG. 6B;

FIG. 7A is a cross-sectional view of the first electrical connector of FIG. 4A or 4F along the line V-V in FIG. 4C, showing the first flexible cable;

FIG. 7B is a cross-sectional view of the first electrical connector of FIG. 4A or 4F along the line VI-VI in FIG. 4C, showing the second flexible cable;

FIG. 8A is a cross-sectional perspective view of the first electrical connector of FIG. 4A or 4F along the line VIII-VIII in FIG. 4D, showing the first flexible cable and the second flexible cable being inserted through channels of the insulative housing, but not locked by beams of the insulative housing;

FIG. 8B is a cross-sectional perspective view similar to FIG. 8A, showing the first flexible cable and the second flexible cable disposed in position in the insulative housing and locked in by the beams of the insulative housing;

FIG. 9A is a perspective view of a first exemplary embodiment of the second electrical connector of FIG. 1A;

FIG. 9B is an exploded perspective view of the second electrical connector of FIG. 9A, showing an insulative housing, a hold-down tab, and a plurality of conductive elements;

FIG. 9C is a perspective view of the second electrical connector of FIG. 9A;

FIG. 9D is an enlarged view of the region 9D in FIG. 9C;

FIG. 9E is a front view of the second electrical connector of FIG. 9A;

FIG. 10A is a perspective view of a first (e.g., upper) conductive element of FIG. 9A;

FIG. 10B is a perspective view of a second (e.g., lower) conductive element of FIG. 9A;

FIG. 10C is a cross-sectional perspective view along the line 10C-10C of FIG. 10A;

FIG. 10D is an enlarged view of the area 10D in FIG. 1C, showing tail ends of the first conductive elements and the second conductive elements connected to pads of the circuit board;

FIG. 11 is a perspective view of the insulative housing of the second electrical connector of FIG. 9A;

FIG. 12A is an exploded perspective view of a second exemplary embodiment of the second electrical connector of FIG. 1A, showing an insulative housing, a hold-down tab, and a plurality of conductive elements;

FIG. 12B is an enlarged view of the area 12B in FIG. 12A, showing first (e.g., upper) conductive elements and second (e.g., lower) conductive elements;

FIG. 13A is a perspective view of the first conductive element of FIG. 12B;

FIG. 13B is a perspective view of the second conductive element of FIG. 12B;

FIG. 14 is a perspective view similar to FIGS. 3A and 3B, showing the second electrical connector of FIG. 12A mated with the first electrical connector mounted on the circuit board;

FIG. 15A is an enlarged view of the region 15A in FIG. 4B;

FIG. 15B is a perspective view of a second latching member of the first electrical connector of FIG. 4A;

FIG. 16A is a perspective view of the electronic system, which schematically illustrates that an operating tool is engaged with the first electrical connector to un-mate the first electrical connector from the second electrical connector;

FIG. 16B is a perspective view of the electronic system of FIG. 1A, which schematically illustrates using an operating tool with the first electrical connector to un-mate the first electrical connector from the second electrical connector;

FIG. 16C is an enlarged view of the region 16C in FIG. 16B;

FIG. 16D is a side view of the electronic system of FIG. 16A, showing the first electrical connector starting to un-mate from the second electrical connector; and

FIG. 16E is a side view similar to FIG. 16B, showing the first electrical connector completely un-mated from the second electrical connector.

### DETAILED DESCRIPTION

The inventors have recognized and appreciated techniques for making compact reliable connectors for use in a harsh environment such as one presented by an automobile. For example, the connector may be used to connect a battery management system (BMS) and cell sensing circuit (CSC) in automobiles. The connector may be compatible with related standards such as USCAR-2 and TC9.

According to aspects of the present disclosure, a plug connector may include an insulative housing, a plurality of flexible cables, and one or more latching member. The plurality of flexible cables may include a flexible flat cable (FFC), and/or a flexible circuit board (FPC), which may be used to transfer signals and/or power between different PCBs or components on the same PCB.

Each flexible cable may include a connecting end having a plurality of conductive contacts configured to contact with complementary contacts of a mating connector (e.g., a receptacle connector). The connecting ends of the plurality of flexible cables may be disposed in the insulative housing. The insulative housing may include a base portion and an accommodation portion extending from the base portion and beyond the conductive contacts of flexible cables, which can reduce the risk of contaminating the conductive contacts of the flexible cables by, for example, a user's finger or a tool. Such a configuration can improve the safety and reliability of the plug connector.

For each flexible cable, the connecting end may include a first segment extending in the base portion of the housing, and a second segment extending from the first segment and into an accommodation space enclosed by the accommodation portion. The second segments of the flexible cables may include the conductive contacts.

A latching member may be mounted to the base portion of the insulative housing and configured to hold the first segments of the connecting ends of the flexible cables in the insulative housing. The latching member may be configured to move between a pre-locked position and a locked position. Such a configuration can enable the plug connector to be pre-locked before the plurality of flexible cables are disposed in the insulative housing, and therefore reduce the risk of accidentally disengaging the latching member when inserting the plurality of flexible cables.

One or more latching beams may extend from the base portion of the housing into the accommodation space of the housing. The latching beams may be configured to hold the second segments of the connecting ends of the flexible cables in the insulative housing.

Techniques described herein can enable the connecting ends of the flexible cables to be disposed directly in the insulative housing for establishing electrical connections with a mating electrical component (e.g., a receptacle connector). Techniques described herein can enable the plug connector to have a simpler structure and less manufacturing cost than conventional connectors that utilize crimped cables.

According to aspects of the present disclosure, a receptacle connector may include an insulative housing and a plurality of conductive elements disposed in the insulative housing. The insulative housing may include a base portion and a tongue portion extending from the base portion in a mating direction. The tongue portion may include a top surface and a bottom surface opposite to each other in a vertical direction perpendicular to the mating direction. Each conductive element may include a mating end having a mating contact portion, a tail end opposite to the mating end, and an intermediate portion joining the mating end and the tail end.

The plurality of conductive elements may include a plurality of first conductive elements and a plurality of second conductive elements. The plurality of first conductive elements may be arranged in a first row in a longitudinal direction perpendicular to both the mating direction and the vertical direction. The plurality of second conductive elements may be arranged in a second row in the longitudinal direction.

The mating ends of the plurality of first conductive elements may extend into the tongue portion with the mating contact portions thereof protruding from the top surface of the tongue portion. The mating ends of the plurality of second conductive elements may extend into the tongue portion with the mating contact portions thereof protruding from the bottom surface of the tongue portion. The mating ends of the plurality of first conductive elements and the mating ends of the plurality of second conductive elements may be offset from each other in the vertical direction. Such a configuration can reduce a spacing in the vertical direction between the first row and the second row, while still ensuring sufficient distance between the mating ends of the first conductive elements and the mating ends of the second conductive elements. Techniques described herein can enable the receptacle connector to have a lower profile (e.g., in the vertical direction Z) than conventional connectors. This facilitates miniaturization of the receptacle connector and enables a reduction of the footprint of the receptacle connector in the electronic system.

The tail ends of the plurality of first conductive elements and the tails ends of the plurality of second conductive elements may be offset in both the vertical direction and the mating direction. In some embodiments, the receptacle connector may include a plurality of protrusion protruding from a rear surface of the base portion of the housing in the mating direction. The tail ends of the plurality of second conductive elements may extend out of respective protrusions of the plurality of protrusions. The tail ends of the plurality of first conductive elements may extend out of the rear surface of the base portion of the housing and between respective adjacent protrusions of the plurality of protrusions protruding from the rear surface of the base portion.

With such a configuration, the creepage distances between the tail ends of the plurality of first conductive elements and the tail ends of the plurality of second conductive elements can be increased, thereby enabling the plurality of first conductive elements and the plurality of second conductive elements to be arranged at closer spacing, and to increase the dielectric withstanding voltage performance of the receptacle connector. Techniques described herein can enable the receptacle connector to have smaller dimensions in the mating direction and/or in the longitudinal direction while providing a desired clearance and creepage distance, such as those dictated by standards for automotive connectors. This facilitates miniaturization of the receptacle connector and enables reduction of the footprint of the receptacle connector in an electronic system.

The mating end of each conductive element of the receptacle connector may have two or more beams each providing a contact portion. In some embodiments, the mating end of each conductive element may include first and second beams aligned in the vertical direction. The first beam may extend beyond the second beam in the mating direction such that the contact portions of the first and second beams are aligned in the mating direction. Such a configuration can improve the reliability of the electrical connections provided by the receptacle connector. Such a configuration can improve the current-carrying capacity of the conductive elements, enabling the receptacle connector to meet the needs of transmitting high currents. Such a configuration can increase the contact density of the receptacle connector, facilitating miniaturization of the receptacle connector.

According to aspects of the present disclosure, an electronic system may include a receptacle connector configured to mount on a circuit board, and a plug connector configured to mate with each other to form a connector assembly.

The plug connector may include an overhanging component, with a proximal end connected to a front of the connector housing and a distal end pointing to a rear of the connector housing. The overhanging component may include first and second beams extending between the proximal end and the free end, and a third beam connecting the first and second beams at the free end. The connector housing of the plug connector may include a flange portion substantially aligned with the third beam of the overhanging portion. The flange portion and/or the third beam of the overhanging portion may be configured to engage a front face of the receptacle connector when the plug connector is mated with the receptacle connector.

The accommodation portion of the housing of the receptacle connector may include a recess configured to receive at least a portion of the overhanging component of the plug connector. The accommodation portion of the housing of the receptacle connector may include a bulge configured to engage the overhanging component of the plug connector.

The electronic system may include a connector position assurance (CPA) device configured for engaging both the overhanging component of the plug connector and the recess of the accommodation portion of the housing of the receptacle connector so as to secure the plug connector to the receptacle connector.

The plug connector and the receptacle connector may have guide features configured to cooperate with each other. Such guide features can reduce the risk of inserting the plug connector from into the receptacle connector in a skewed orientation, thereby providing protection to the mating conductive structures of the plug connector and the receptacle connector, and enabling the connectors to operate while the system is running and operational (which may be referred to as hot-plugging or hot swapping).

Some embodiments of the present application are described in detail below in conjunction with the accompanying drawings.

### Electronic System

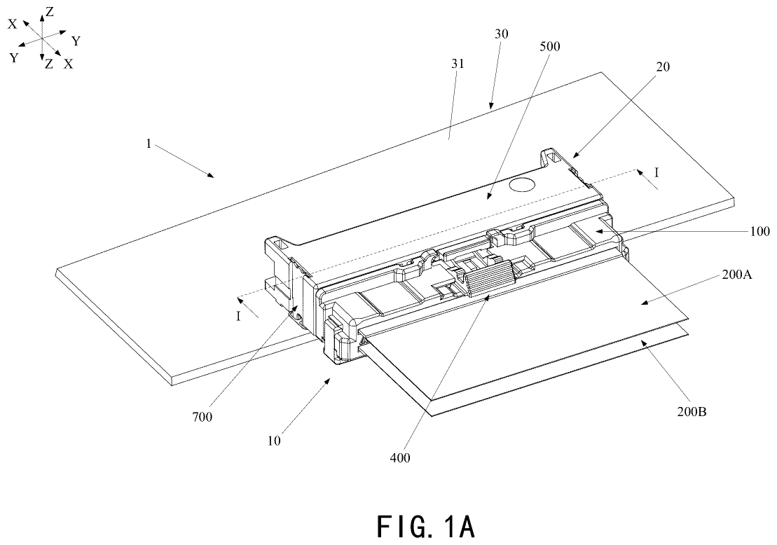

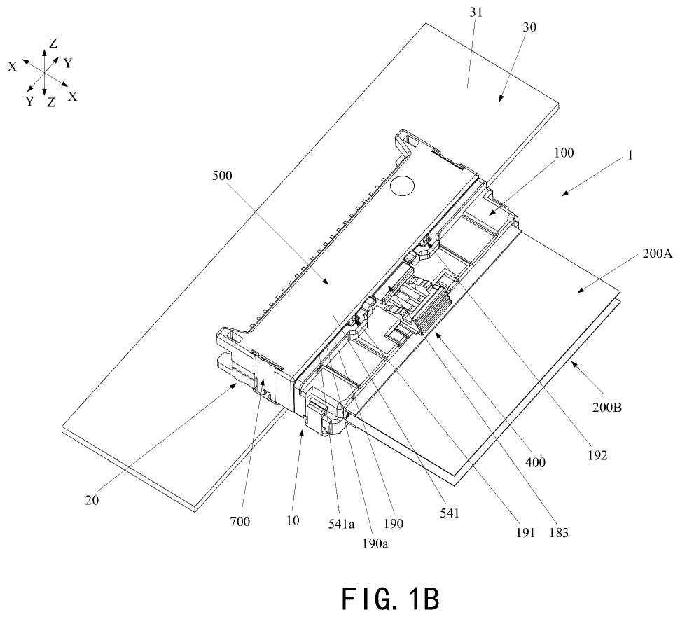

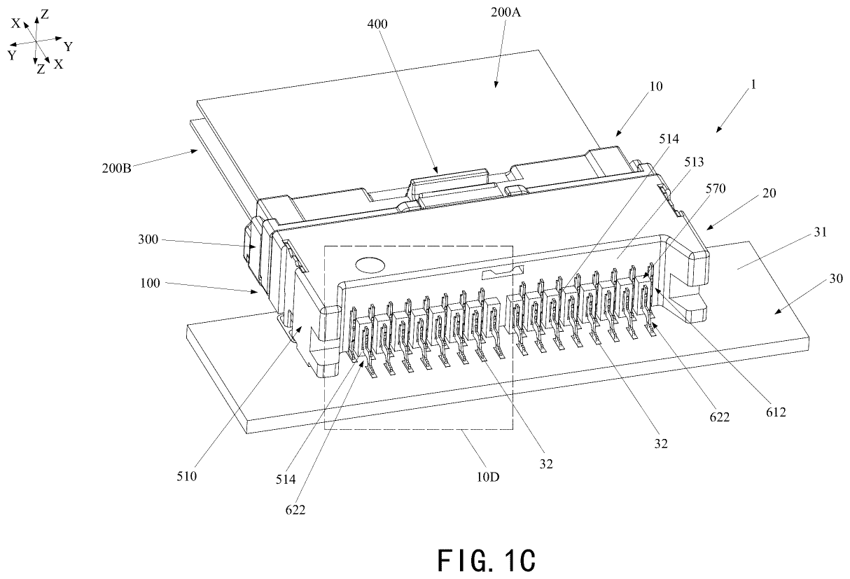

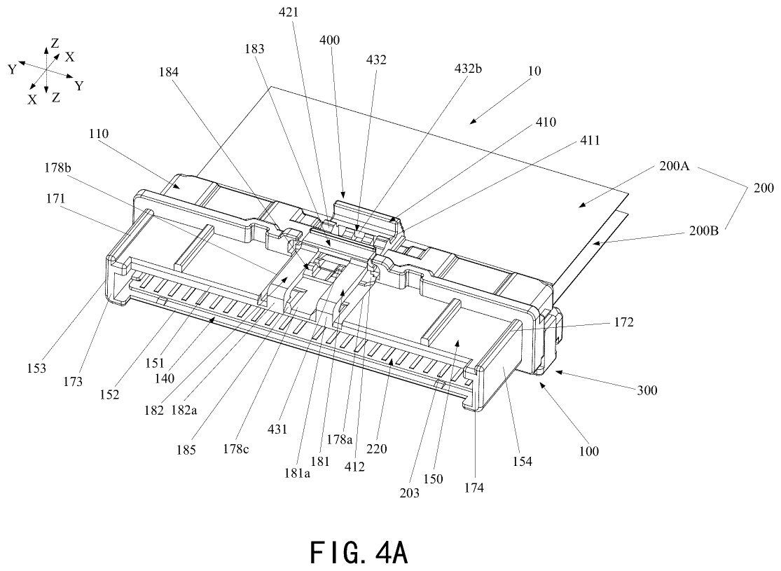

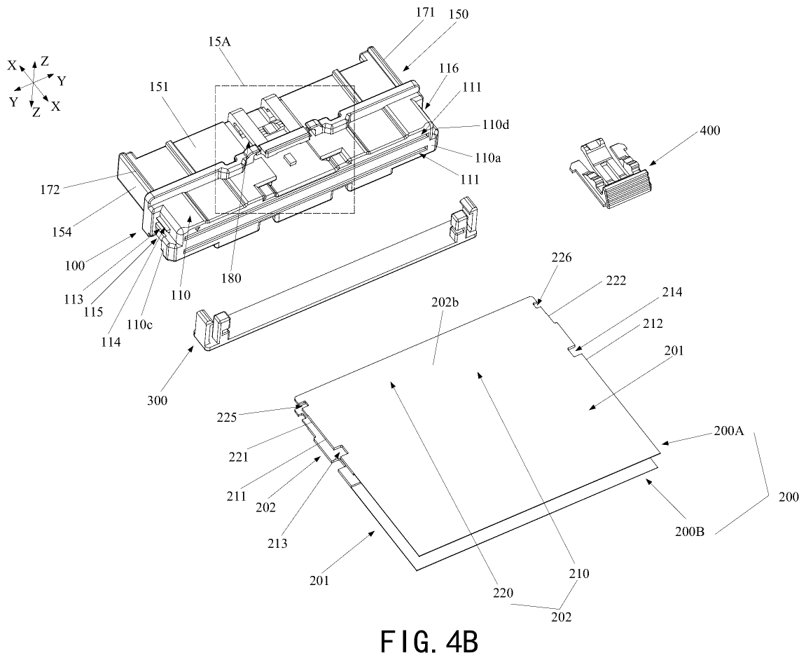

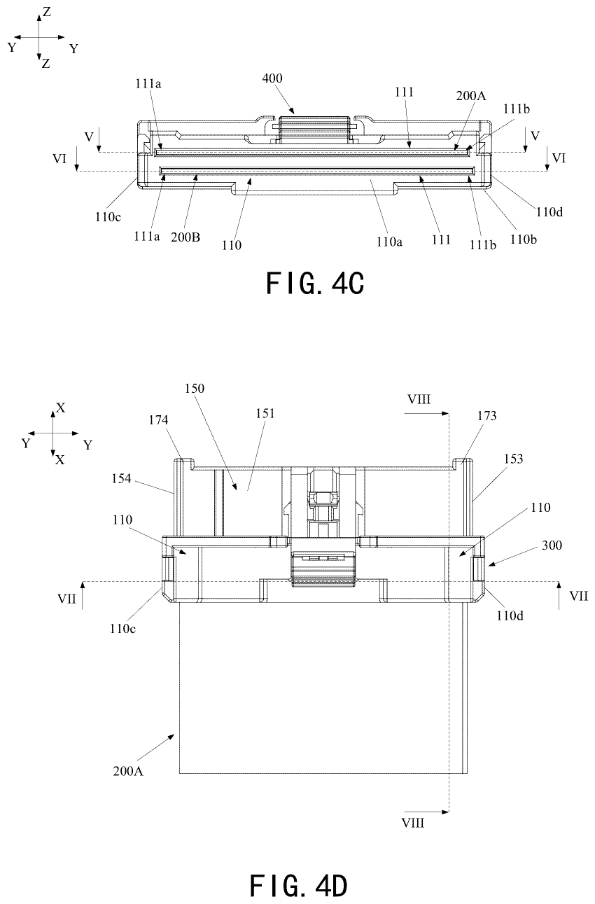

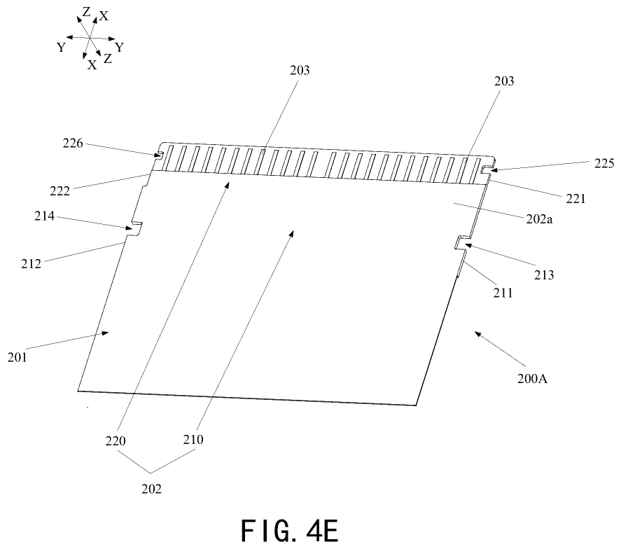

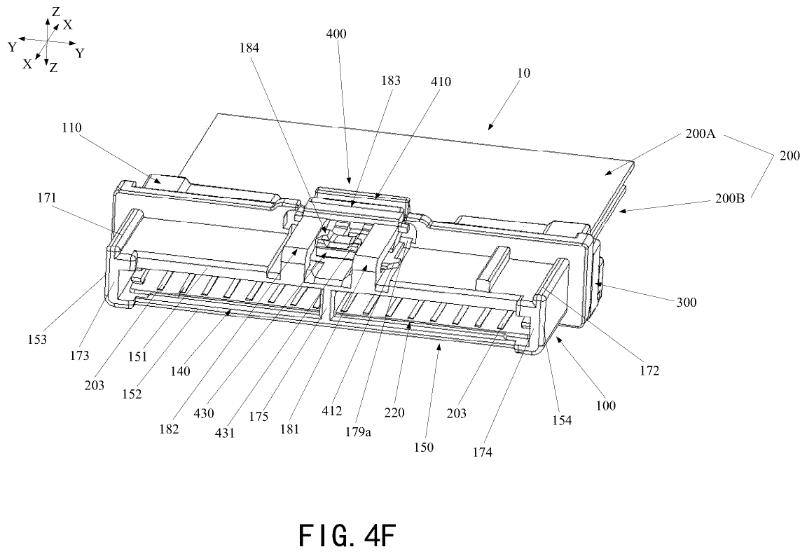

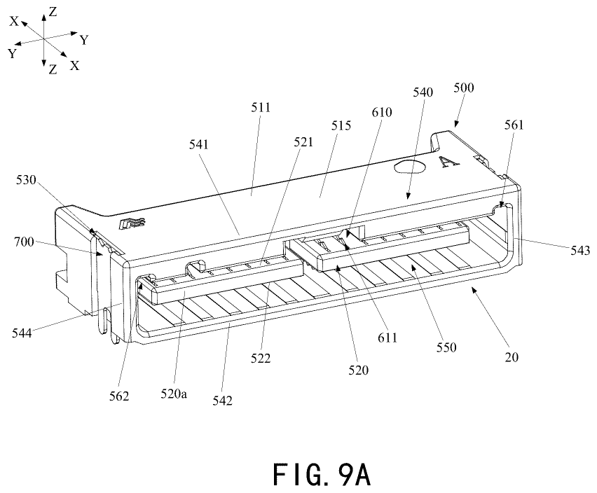

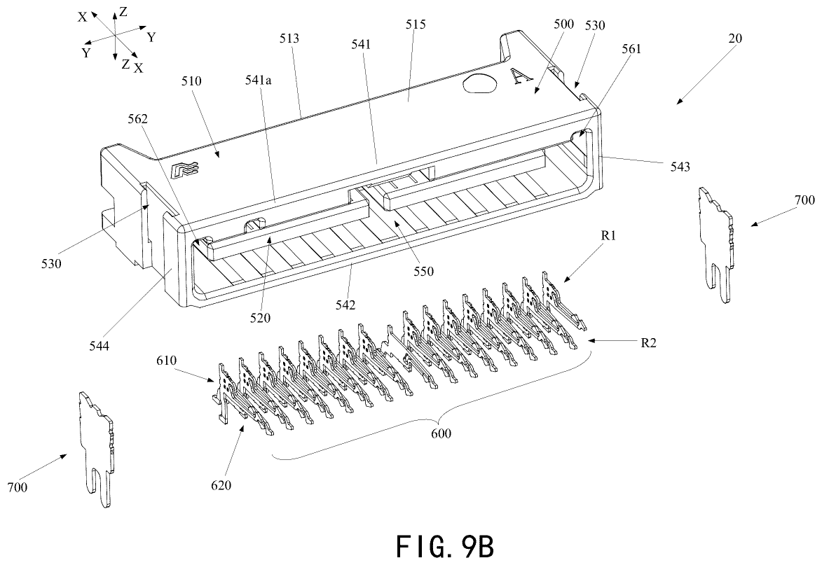

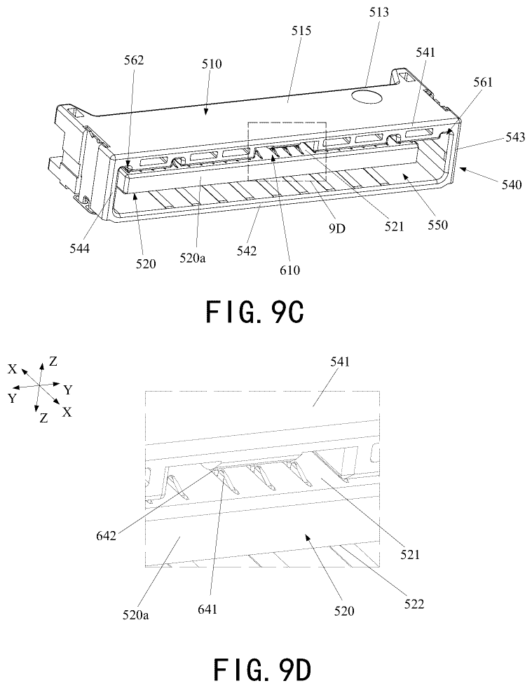

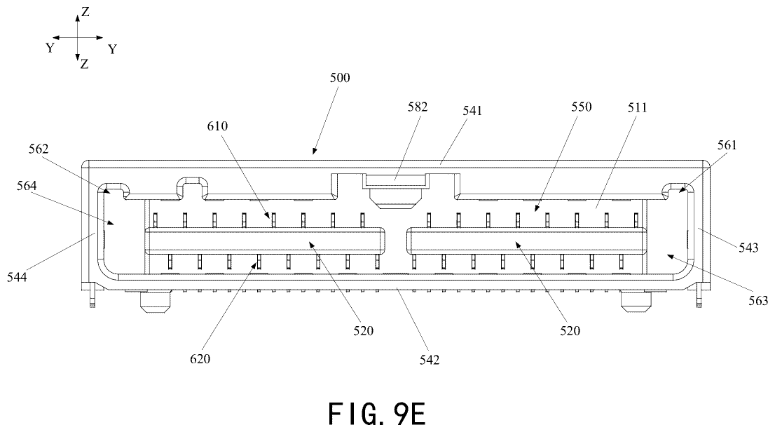

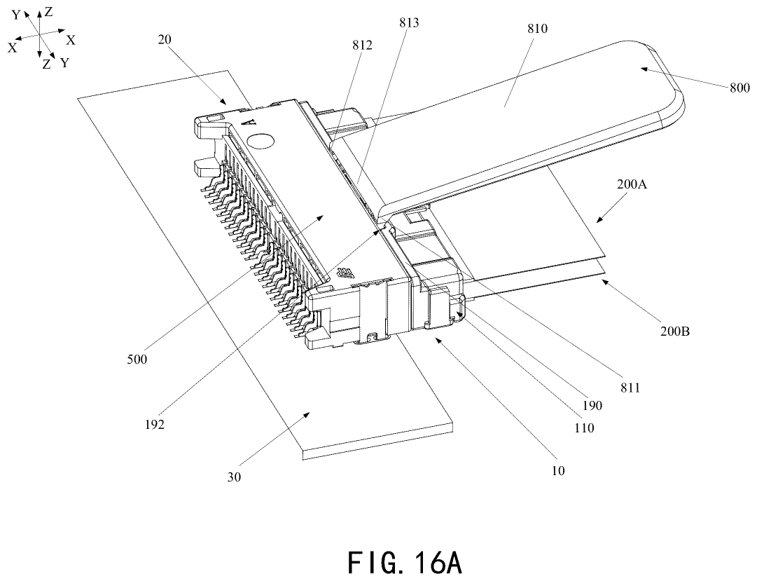

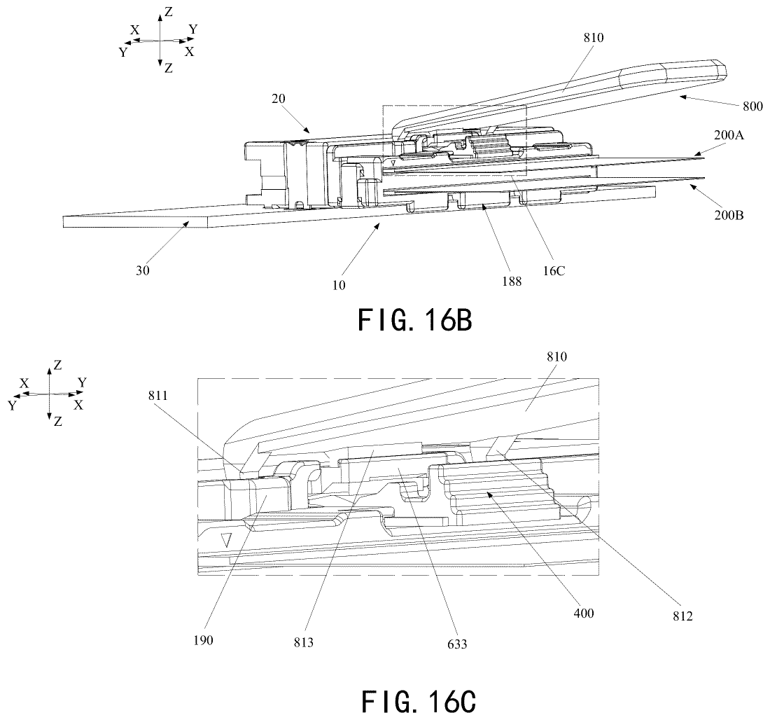

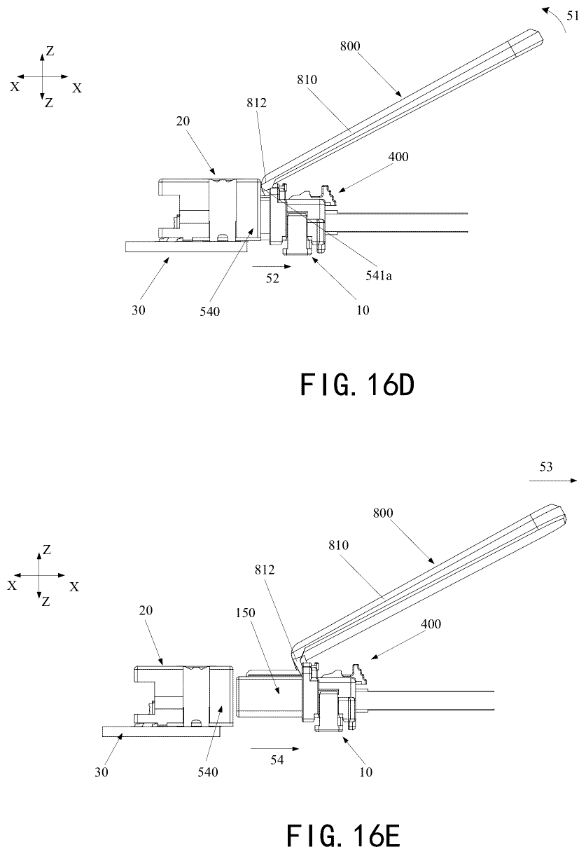

According to aspects of the present disclosure, FIGS. 1A to 3B illustrate an electronic system 1, including an electrical connector 10, an electrical connector 20, and a circuit board 30. FIGS. 4A to 8B and 15A to 15B illustrate the electrical connector 10. FIGS. 9A to 14 illustrate the electrical connector 20. FIGS. 16A to 16E schematically illustrate an exemplary process for un-mating the electrical connector 10 from the electrical connector 20.

For the sake of clarity and conciseness of the description, a lateral direction X-X, a longitudinal direction Y-Y, and a vertical direction Z-Z may be shown in FIGS. 1A to 16E. The lateral direction X-X, the longitudinal direction Y-Y, and the vertical direction Z-Z may be perpendicular to each other. The lateral direction X-X may refer to a width direction of the electrical connector 10 and/or the electrical connector 20. The longitudinal direction Y-Y may refer to a length direction of the electrical connector 10 and/or the electrical connector 20. The vertical direction Z-Z may refer to a height direction of the electrical connector 10 and/or the electrical connector 20.

As shown in FIGS. 1A to IC, the electronic system 1 includes the electrical connector 10, the electrical connector 20, and the circuit board 30.

In some embodiments, the circuit board 30 may be referred to as “a printed circuit board” or “a PCB.” The circuit board 30 may be a motherboard, such as a motherboard for a battery management system (BMS).

The electrical connector 20 may be an on-board connector that is mounted on and connected to the circuit board 30. For example, the electrical connector 20 may be mechanically secured to the circuit board 30 and electrically connected to conductive structures (e.g., conductive pads or conductive through-holes) of the circuit board 30. The electrical connector 20 may provide an electrical interface for electrically connecting the electrical connector 10 to the circuit board 30.

The electrical connector 10 may be configured to electrically connect an electrical component to the electrical connector 20 and the circuit board 30. The electrical component may be, for example, a Cell Sensing Circuit (CSC) configured for monitoring the state (e.g., the voltage and the temperature) of a battery cell.

The electrical connector 10 and the electrical connector 20 may establish an electrical connection between the circuit board 30 and the electrical component for signal and/or power transmission. For example, state data of the battery cell acquired by the CSC may be transferred to a data obtaining module of the BMS via the electrical connector 10 and the electrical connector 20. The electrical connector 10 and the electrical connector 20 may constitute a connector assembly for signal and/or power transmission. It should be appreciated that the usage of the electronic system 1 and the connector assembly according to the present application are not limited thereto. In some embodiments, the electrical connector 10 and the electrical connector 20 may be used in an On-board Charger (OBC), a micro control unit (MCU), and the like.

As shown in FIGS. 1A to 3B, the electrical connector 20 is disposed on a surface 31 of the circuit board 30 and is electrically connected to the conductive structures 32 (which are illustrated as conductive pads in FIG. 1C) of the circuit board 30. As will be described in detail below, a portion of the electrical connector 10 is inserted into a housing of the electrical connector 20 so that the conductive structures of the electrical connector 10 mate with the mating conductive structures of the electrical connector 20. In some embodiments, the electrical connector 10 may be referred to as “a first electrical connector” or “a plug connector,” and the electrical connector 20 may be referred to as “a second electrical connector” or “a receptacle connector.”

### Plug Connector

FIGS. 4A to 8B illustrate the electrical connector 10. As shown in FIGS. 4A and 4B, the electrical connector 10 may include an insulative housing 100, a plurality of flexible cables 200, a latching member 300, and a latching member 400.

In some embodiments, the flexible cable 200 may be a flexible electrical connection member with a flat shaped connecting end. The flexible cable 200 may be referred to as “a flat cable.” For example, the flexible cable 200 may be electrically connected to an electrical component, such as a CSS as described above, or the flexible cable 200 may itself be a part of an electrical component such as a CSS as described above. The flexible cable 200 may, for example, be a Flexible Printed Circuit (FPC) or a Flexible Flat Cable (FFC). The plurality of flexible cables 200 of the electrical connector 10 may include an FFC, an FPC, or the combination thereof.

The plurality of flexible cables 200 are shown in FIGS. 4A and 4B as two flexible cables: a first flexible cable 200A and a second flexible cable 200B. The first flexible cable 200A may be referred to as “an upper flexible cable,” and the second flexible cable 200B may be referred to as “a lower flexible cable.” The configuration of the electrical connector 10 is described in detail below in connection with an example of the electrical connector 10 including two flexible cables. It should be appreciated that the present application may not be limited thereto, and that the electrical connector 10 may include more than two (e.g., three, four, five, etc.) flexible cables.

FIG. 4B illustrates a first side of the first flexible cable 200A, and FIG. 4E illustrates a second side of the first flexible cable 200A opposite to the first side. As shown in FIGS. 4B and 4E, the first flexible cable 200A includes a main body 201 and a connecting end 202.

The connecting end 202 may have a flat shape. The connecting end 202 may include a first surface 202a and a second surface 202b opposite to each other in the vertical direction Z-Z. A plurality of conductive contacts 203 may be exposed at the first surface 202a of the connecting end 202. The conductive contacts 203 may be referred to as “conductive contact strips” or “gold fingers.” The conductive contacts 203 may be formed from a conductive material. The conductive material suitable for forming the conductive contact 203 may be a metallic material, such as a copper alloy. The main body 201 may extend from the connecting end 202 to the other end (not shown) of the first flexible cable 200A, and may provide an electrical connection between the connecting end 202 and the other end, thereby enabling signal and/or power transmission. The main body 201 may, for example, be flexible so as to be suitable for bending. The connecting end 202 may be stiffened so as to be suitable for being inserted into the insulative housing 100 as well as for establishing an electrical connection with a mating electrical component (e.g., the electrical connector 20).

The structures of the second flexible cable 200B may be substantially similar to those of the first flexible cable 200A. For the sake of brevity, the structures of the second flexible cable 200B that may be similar to those of the first flexible cable 200 are labeled with the same reference signs in the appended drawings, and the details of these structures will not be repeated.

As shown in FIGS. 4A, 4C, and 4D, the connecting end 202 of the first flexible cable 200A and the connecting end 202 of the second flexible cable 200B are disposed in the insulative housing 100. The latching member 300 is mounted to the insulative housing 100 and may be configured to hold and lock the connecting end 202 of the first flexible cable 200A and the connecting end 202 of the second flexible cable 200B in the insulative housing 100. The latching member 300 may be referred to as “a first latching member” or “an FPC/FFC position assurance (FPA) device.”

With such a configuration, the connecting end 202 of the first flexible cable 200A and the connecting end 202 of the second flexible cable 200B may be disposed directly in the insulative housing 100 to establish electrical connections with a mating electrical component. Such a configuration can simplify the structure of the electrical connector 10 and reduce the production cost thereof as compared to conventional electrical connectors that utilize crimped cables to connect the flat cable. With the latching member 300, the connecting end 202 of the first flexible cable 200A and the connecting end 202 of the second flexible cable 200B can be reliably held in the insulative housing 100. Holding the plurality of flexible cables by the single latching member 300 can simplify the structure and assembly process of the electrical connector 10.

The insulative housing 100 and the latching member 300 may be formed from an insulative material. Examples of insulative materials include, but are not limited to, plastic, nylon, liquid crystal polymer (LCP), polyphenylene sulfide (PPS), high temperature nylon or polyphenylenoxide (PPO) or polypropylene (PP).

As shown in FIGS. 4B, 4C, 6A, 6B, 8A, and 8B, the insulative housing 100 includes a base portion 110, and two first channels 111 (which may be referred to as top and bottom channels) each extending through the base portion 110 from a rear face 110a of the base portion 110 in the lateral direction X-X. The two first channels 111 are spaced apart from each other in the vertical direction Z-Z perpendicular to the lateral direction X-X. For example, the two first channels 111 may be spaced apart from each other by a portion of the base portion 110 in the vertical direction Z-Z.

As shown in FIGS. 4A and 4E, the connecting end 202 of the first flexible cable 200A may include a first segment 210 and a second segment 220. The first segment 210 of the connecting end 202 extends from the main body 201 in the lateral direction X-X, and the second segment 220 extends from the first segment 210 away from the main body 201 in the lateral direction X-X. For example, the first segment 210 extends between the second segment 220 and the main body 201 and joins the second segment 220 and the main body 201. The first flexible cable 200A may terminate at the second segment 220. The plurality of conductive contacts 203 are disposed on the second segment 220. The structure of the connecting end 202 of the second flexible cable 200B may be substantially similar to that of the connecting end 202 of the first flexible cable 200A. For the sake of brevity, the details of these identical portions will not be repeated.

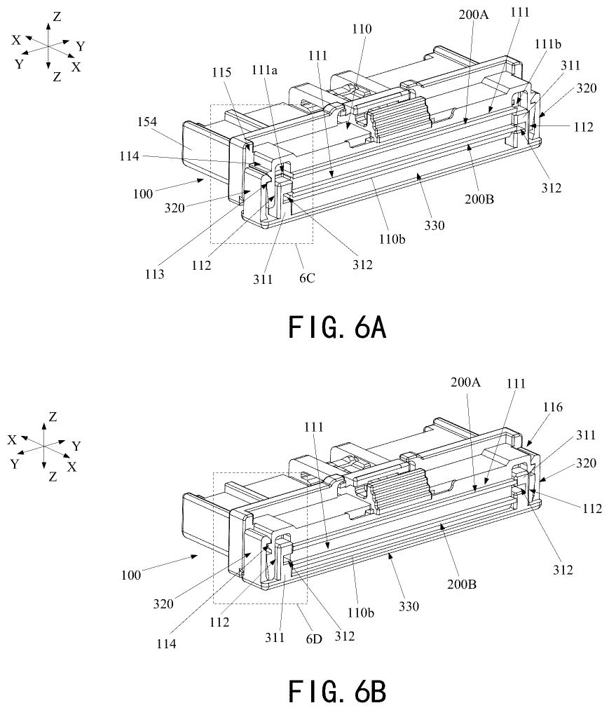

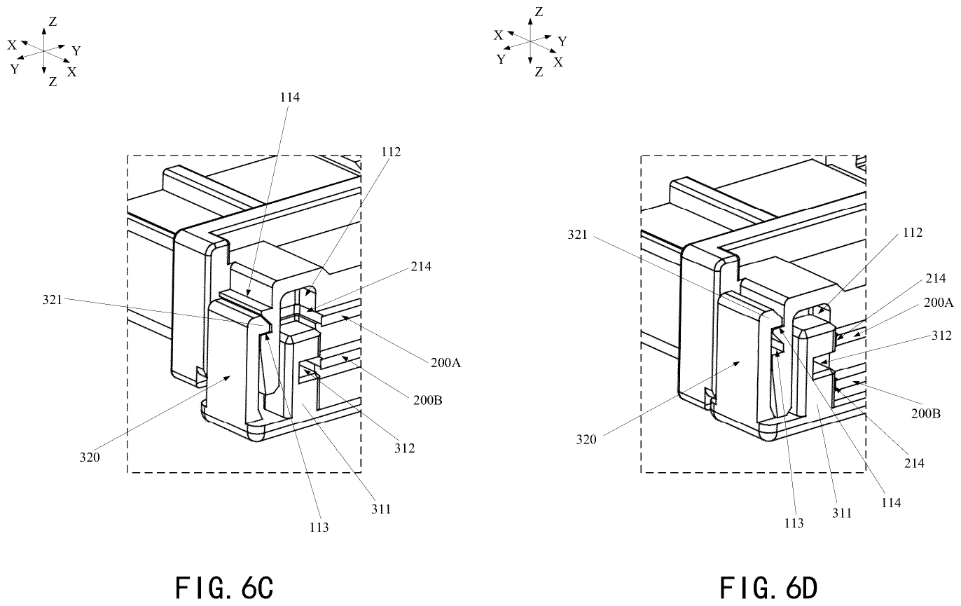

As shown in FIGS. 6A to 8B, the connecting end 202 of each of the first flexible cable 200A and the second flexible cable 200B may be inserted into the insulative housing 100 from the rear face 110a of the base portion 110 through a corresponding one of the two first channels 111. When the first flexible cable 200A and the second flexible cable 200B are disposed in position in the insulative housing 100, the first segment 210 of the connecting end 202 of each of the first flexible cable 200A and the second flexible cable 200B is disposed in a corresponding one of the two first channels 111. The connecting end 202 of the first flexible cable 200A is disposed in the upper first channel 111, and the connecting end 202 of the second flexible cable 200B is disposed in the lower first channel 111. The connecting ends 202 of the first flexible cable 200A and the second flexible cable 200B are spaced apart from each other in the vertical direction Z-Z. With such a configuration, the base portion 110 can restrict the movement of the first segments 210 of the connecting ends 202 of the first flexible cable 200A and the second flexible cable 200B relative to the insulative housing 100 in the longitudinal direction Y-Y and the vertical direction Z-Z, thereby holding the connecting ends 202 of the first flexible cable 200A and the second flexible cable 200B in the longitudinal direction Y-Y and the vertical direction Z-Z.

The first segment 210 of each of the first flexible cable 200A and the second flexible cable 200B may have a side edge. Referring back to FIGS. 4B and 4E, the first segment 210 of the connecting end 202 of the first flexible cable 200A includes a first side edge 211 and a second side edge 212 opposite to each other in the longitudinal direction Y-Y. Similarly, the first segment 210 of the connecting end 202 of the second flexible cable 200B may also include a first side edge 211 and a second side edge 212 opposite to each other in the longitudinal direction Y-Y.

In some embodiments, as shown in FIGS. 6A and 6B, the latching member 300 is mounted to the base portion 110 and is configured to move between a pre-locked position (FIG. 6A) and a locked position (FIG. 6B). For example, the latching member 300 is capable of moving between a pre-locked position/state (FIG. 6A) and a locked position/state (FIG. 6B) while remaining mounted to the base portion 110.

In the pre-locked position as shown in FIG. 6A, the latching member 300 does not engage with the side edges (e.g., the first side edges 211 and/or the second side edges 212) of the first segments 210 of the first flexible cable 200A and the second flexible cable 200B to enable the first segments 210 to move through the first channels 111 in the lateral direction X-X. For example, in the pre-locked position, the latching member 300 is mounted to the base portion 110 and enables the connecting end 202 of each of the first latching member 300 and the second latching member 200B to insert into the insulative housing 100 from the rear face 110a of the base portion 110 through the corresponding first channel 111.

In the locked position as shown in FIG. 6B, the latching member 300 engages with the side edges (e.g., the first side edges 211 and/or the second side edges 212) of the first segments 210 of the first flexible cable 200A and the second flexible cable 200B to hold the first segments 210 in the first channels 111. For example, in the locked position, the latching member 300 may block the first segments 210 from moving in the first channels 111 in the lateral direction X-X, thereby holding the first segments 210 in the first channels 111. In this way, the latching member 300 can hold the connecting ends 202 of the first flexible cable 200A and the second flexible cable 200B in the insulative housing 100.

When placed in the pre-locked position, the latching member 300 can be mounted to the insulative housing 100 and enable the connecting ends 202 of the first flexible cable 200A and the second flexible cable 200B to insert into the insulative housing 100. When placed in the locked position, the latching member 300 holds the connecting ends 202 of the first flexible cable 200A and the second flexible cable 200B in the insulative housing 100. Such a configuration can enable the latching member 300 to be installed to the insulative housing 100 (e.g., enable pre-locking the latching member 300), prior to the insertion of the first flexible cable 200A and the second flexible cable 200B into the insulative housing 100, and enable locking the first flexible cable 200A and the second flexible cable 200B in position by using the latching member 300 pre-installed to the insulative housing 100, after the insertion of the first flexible cable 200A and the second flexible cable 200B into the insulative housing 100. Such a configuration enables the electrical connector 10 to meet the requirements of the specification such as USCAR. As the latching member 300 is pre-locked in position prior to the insertion of the first flexible cable 200A and the second flexible cable 200B, loss of the latching member 300 can be avoided during installation of the first flexible cable 200A and the second flexible cable 200B, and the efficiency of assembly of the electrical connector 10 can be improved.

For each of the first flexible cable 200A and the second flexible cable 200B, a side edge of the first segment 210 is disposed in an end section of the corresponding first channel 111. For example, as shown in FIG. 6A, the first side edge 211 of the first segment 210 is disposed in a first end section 111a of the corresponding first channel 111, and the second side edge 212 is disposed in a second end section 111b of the first channel 111. The first end section 111a and the second end section 111b are disposed at opposite ends of the first channel 111 in the longitudinal direction Y-Y, respectively.

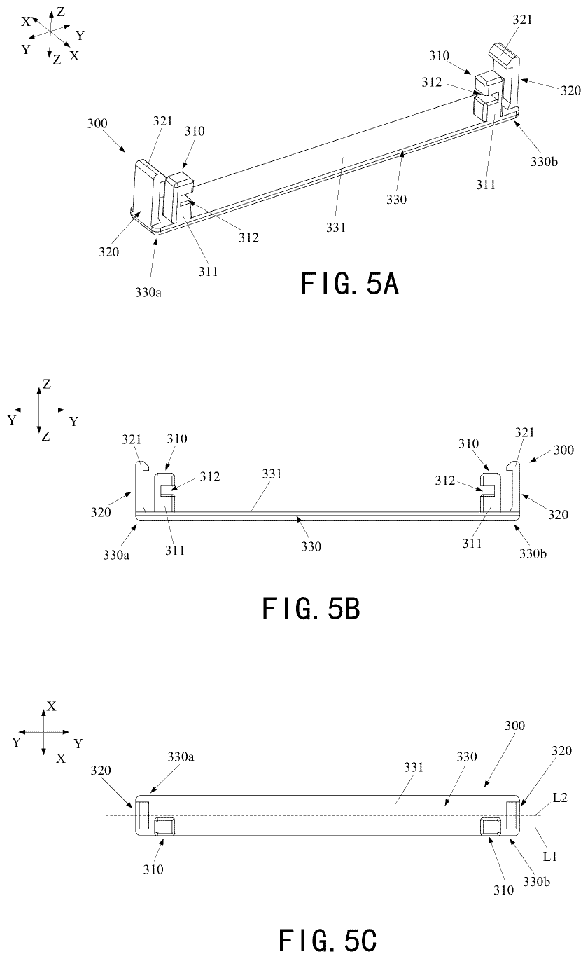

In some embodiments, as shown in FIGS. 6A to 6B, the insulative housing 100 may include two second channels 112. Each of the second channels 112 extends from the exterior of the base portion 110 (which is a second or bottom surface 110b of the base portion 110 in the drawings) into the base portion 110 in the vertical direction Z-Z and through the corresponding end sections of the plurality of first channels 111 (e.g., the corresponding end sections of the first end section 111a and the second end section 111b). As shown in FIGS. 5A to 6B, the latching member 300 may include two first arms 310. Each first arm 310 includes a first body 311 extending in the vertical direction Z-Z, and a first groove 312 extending through the first body 311 in the lateral direction X-X. As shown in FIGS. 6A to 6B, each of the two first arms 310 is inserted into a corresponding one of the two second channels 112, and is configured to be capable of moving in the corresponding second channel 112 in the vertical direction Z-Z.

When the latching member 300 is placed in the pre-locked position, the first groove 312 of each first arm 310 is aligned with the end section of the corresponding first channel 111 in the lateral direction X-X, so as to enable the side edge of the corresponding first segment 210 to move through the end section and the first groove 312 in the lateral direction X-X. For example, as shown in FIGS. 6A and 6C, when the latching member 300 is placed in the pre-locked position, the first groove 312 of one of the two first arms 310 is aligned with the first end section 111a of the lower first channel 111 in the lateral direction X-X, and the first groove 312 of the other one of the two first arms 310 is aligned with the second end section 111b of the lower first channel 111 in the lateral direction X-X. This enables the first side edge 211 and the second side edge 212 of the first segment 210 of the second flexible cable 200B to move through the corresponding end sections and the first groove 312 in the lateral direction X-X, respectively, thereby enabling the connecting end 202 of the second flexible cable 200B to pass through the first channel 111 in the lateral direction X-X. This enables for the connecting end 202 of the second flexible cable 200B to be inserted into and removed from the insulative housing 100 in the lateral direction X-X.

Furthermore, as shown in FIGS. 6A and 6C, when the latching member 300 is placed in the pre-locked position, the tops of the first bodies 311 of the two first arms 310 do not extend in the vertical direction Z-Z into the corresponding end sections of the first channel 111 for inserting the first flexible cable 200A, e.g., the tops of the first bodies 311 of the two first arms 310 are positioned below the corresponding end sections of the first channel 111. This enables the first side edge 211 and the second side edge 212 of the first segment 210 of the first flexible cable 200A to move through the corresponding end sections in the lateral direction X-X, thereby enabling the connecting end 202 of the first flexible cable 200A to pass through the first channel 111 in the lateral direction X-X. This enables the connecting end 202 of the first flexible cable 200A to insert into the insulative housing 100 and to be moved out of the insulative housing 100 in the lateral direction X-X. It should be appreciated that the present application may not be limited thereto. In some embodiments, the first body 311 of the first arm 310 may include an additional first groove 312 that is configured to align with the corresponding end section of the upper first channel 111 for inserting the first flexible cable 200A when the latching member 300 is placed in the pre-locked position.

For example, each first arm 310 may include at least one first groove 312 extending through the first body 311 in the lateral direction X-X. When the latching member 300 is placed in the pre-locked position, each of the at least one first groove 312 of each first arm 310 may be aligned with the end section of a corresponding one of the plurality of first channels 111 in the lateral direction X-X, so as to enable the side edges of the corresponding first segment 210 to move through the end sections and the first groove 312 in the lateral direction X-X.

In some embodiments, the first segment 210 of each of the first flexible cable 200A and the second flexible cable 200B may include a notch recessed into the first segment 210 from the side edge in the longitudinal direction Y-Y. For example, as shown in FIG. 4E, the first segment 210 of the first flexible cable 200A may include a first notch 213 recessed into the first segment 210 from the first side edge 211 in the longitudinal direction Y-Y and a second notch 214 recessed into the first segment 210 from the second side edge 212 in the longitudinal direction Y-Y. The structure of the first segment 210 of the second flexible cable 200B may be substantially similar to that of the first segment 210 of the first flexible cable 200A, and may include the first notch 213 and the second notch 214. For the sake of brevity, the details of these identical portions will not be repeated.

When the first flexible cable 200A and the second flexible cable 200B are disposed in position in the insulative housing 100, the corresponding notches of the first segments 210 of the first flexible cable 200A and the second flexible cable 200B are aligned with each other in the vertical direction Z-Z and aligned with a corresponding one of the two second channels 112. For example, when the first flexible cable 200A and the second flexible cable 200B are disposed in position in the insulative housing 100, the first notches 213 (which are at the first side edges 211) of the first segments 210 of the first flexible cable 200A and the second flexible cable 200B are aligned with each other in the vertical direction Z-Z and aligned with the corresponding one of the two second channels 112, and the second notches 214 (which are at the second side edges 212) of the first segments 210 of the first flexible cable 200A and the second flexible cable 200B are aligned with each other in the vertical direction Z-Z and aligned with the other one of the two second channels 112.

When the latching member 300 is placed in the locked position, the first groove 312 of the first arm 310 of the latching member 300 is moved to be offset from the end sections of the plurality of first channels 111 in the lateral direction X-X, and the first body 311 of the first arm 310 is moved into and engaged with the notches of the first segments 210 of the first flexible cable 200A and the second flexible cable 200B, so as to retain the first segments 210 in the first channels 111. For example, as shown in FIGS. 6B and 6D, when the latching member 300 is placed in the locked position, the first groove 312 of one of the two first arms 310 is moved to be offset from the first end sections 111a of the two first channels 111 in the lateral direction X-X, and the first groove 312 of the other one of the two first arms 310 is moved to be offset from the second end sections 111b of the two first channels 111 in the lateral direction X-X. The first body 311 of one of the two first arms 310 is moved into the first notch 213 of the first segment 210 of the first flexible cable 200A and the first notch 213 of the first segment 210 of the second flexible cable 200B, and engages with the two first notches 213. For example, a lower segment of the first body 311 is received in the first notch 213 of the second flexible cable 200B and an upper segment of the first body 311 is received in the first notch 213 of the first flexible cable 200A. The first body 311 of the other one of the two first arms 310 is moved into the second notch 214 of the first segment 210 of the first flexible cable 200A and the second notch 214 of the first segment 210 of the second flexible cable 200B and engages with the two second notches 214. The lower segment of the first body 311 is received in the second notch 214 of the second flexible cable 200B, and the upper segment of the first body 311 is received in the second notch 214 of the first flexible cable 200A. In this way, the first segment 210 of the first flexible cable 200A and the first segment 210 of the second flexible cable 200B are reliably held in the corresponding first channels 111, respectively, so that the connecting ends 202 of the first flexible cable 200A and the second flexible cable 200B are held in the insulative housing 100.

As shown in FIGS. 5A to 5C, the latching member 300 may include a plate body 330, which may be referred to as “a press plate.” Each of the two first arms 310 extends from the plate body 330 in the vertical direction Z-Z. The latching member 300 may further include two second arms 320. The two second arms 320 may be configured to attach the latching member 300 to the base portion 110 of the insulative housing 100. Each of the second arms 320 extends from the plate body 330 in the vertical direction Z-Z and includes a bulge 321. The second arm 320 may be a flexible arm. The bulge 321 may be in the shape of a barb. The bulges 321 of the two second arms 320 are opposite to each other in the longitudinal direction Y-Y.

As shown in FIGS. 4B, 6C, and 6D, the base portion 110 may include two first slots 113 and two second slots 114. The bulge 321 of each of the two second arms 320 is configured to be capable of being selectively snapped into a corresponding first slot 113 and a corresponding second slot 114, when the latching member 300 is mounted to the base portion 110. As shown in FIGS. 6A and 6C, the latching member 300 is placed in the pre-locked position when the bulge 321 of each of the two second arms 320 is snapped into the corresponding first slot 113. As shown in FIGS. 6B and 6D, the latching member 300 is placed in the locked position when the bulge 321 of each of the two second arms 320 is snapped into the corresponding second slot 114. With such a snap fit, the latching member 300 can be reliably held in the pre-locked position and the locked position, while the switching of the latching member 300 between the pre-locked position and the locked position can be facilitated.

For example, when the latching member 300 is placed in the pre-locked position, the latching member 300 may be pushed to cause the two second arms 320 to be moved from the corresponding first slots 113 into the corresponding second slots 114 by pressing the plate body 330 in the vertical direction Z-Z, so as to move the latching member 300 to the locked position. When the latching member 300 is placed in the locked position, the two second arms 320 may be released from the corresponding second slots 114 and the two second arms 320 may be snapped into the corresponding first slots 113, so as to place the latching member 300 in the pre-locked position. Furthermore, the latching member 300 may be removed from the base portion 110 by releasing the two second arms 320 from the corresponding first slots 113 or the corresponding second slots 114.

In some embodiments, as shown in FIG. 5C, the two first arms 310 of the latching member 300 may each extend from the first surface 331 of the plate body 330 in the vertical direction Z-Z, and the two first arms 310 may be aligned with each other in the longitudinal direction Y-Y along a first center line L1. The two second arms 320 may each extend from the first surface in the vertical direction Z-Z, and the two second arms 320 may be aligned with each other in the longitudinal direction Y-Y along a second center line L2. In some embodiments, the first center line L1 and the second center line L2 do not overlap with each other. Such a configuration can provide a fool-proof function to prevent the latching member 300 from being mounted to the base portion 110 in an improper orientation.

As shown in FIGS. 5A to 5C, the plate body 330 of the latching member 300 includes a first end 330a and a second end 330b opposite to each other in the longitudinal direction Y-Y. Two second arms 320 extend from the first surface 331 of the plate body 330 in the vertical direction Z-Z at the first end 330a and the second end 330b, respectively. The two first arms 310 may extend from the first surface 331 of the plate body 330 in the vertical direction Z-Z between the two second arms 320.

As shown in FIGS. 4B, 6A, and 6B, the base portion 110 includes a first end face 110c and a second end face 110d opposite to each other in the longitudinal direction Y-Y, a second groove 115 recessed into the base portion 110 from the first end face 110c in the longitudinal direction Y-Y, and a third groove 116 recessed into the base portion 110 from the second end face 110d in the longitudinal direction Y-Y. The aforementioned first slot 113 and the second slot 114 are formed at the bottom of the second groove 115 and the bottom of the third groove 116, respectively. The two second arms 320 of the latching member 300 are received in the second groove 115 and the third groove 116, respectively, when the latching member 300 is mounted to the base portion 110. In this way, the two second arms 320 of the latching member 300 can be protected by the base portion 110 from loosening from the base portion 110 due to accidental touching. With such a configuration, the reliability of the installation of the latching member 300 to the base portion 110 can be improved, and the installation, adjustment, and removal of the latching member 300 can be facilitated.

As shown in FIGS. 4A and 4B, the insulative housing 100 may include an accommodation portion 150. The accommodation portion 150 extends from the base portion 110 in the lateral direction X-X and encloses an accommodation space 140. The accommodation space 140 is open at an end opposite to the base portion 110. The second segments 220 of the first flexible cable 200A and the second flexible cable 200B are positioned in the accommodation space 140. With such a configuration, the conductive contacts 203 of the first flexible cable 200A and the second flexible cable 200B can be protected by the accommodation portion 150 from being touched by a user's finger or by a tool, thereby prevent the user from getting electric shock or avoiding a short circuit. Such a configuration can improve the safety and reliability of the electronic system 1 using the electrical connector 10.

For example, the leading edges of the second segments 220 of the connecting ends 202 of the first flexible cable 200A and the second flexible cable 200B may each be indented into the accommodation portion 150 by a certain distance relative to the opening of the accommodation portion 150 in the lateral direction X-X. For example, the distance may be greater than or equal to 1 mm.

The accommodation portion 150 of the insulative housing 100 may be formed by a plurality of walls extending from the base portion 110 in the lateral direction X-X. The plurality of walls may include a first wall 151 and a second wall 152 that are opposite to each other and spaced apart from each other in the vertical direction Z-Z, and a third wall 153 and a fourth wall 154 that are opposite to each other and spaced apart from each other in the longitudinal direction Y-Y. The first wall 151 and second wall 152 may be referred to as top and bottom walls, respectively. The third wall 153 and fourth wall 154 may be referred to as sidewalls. The first wall 151, the second wall 152, the third wall 153, and the fourth wall 154 enclose the accommodation space 140. Furthermore, the accommodation portion 150 may be used as a mating portion of the insulative housing 100 for insertion into a housing of another electrical connector (e.g., the electrical connector 20 to be described below) that mates with the electrical connector 10.

The second segment 220 of the first flexible cable 200A and the second segment 220 of the second flexible cable 200B are adjacent to each other and spaced apart from each other in the vertical direction Z-Z. The plurality of conductive contacts 203 of the first flexible cable 200A (which are disposed on the second segment 220) and the plurality of conductive contacts 203 of the second flexible cable 200B (which are disposed on the second segment 220) are opposite to each other and spaced apart from each other in the vertical direction Z-Z. For example, the second segment 220 of the first flexible cable 200A and the second segment 220 of the second flexible cable 200B may bound a slot therebetween, which may be elongated in the longitudinal direction Y-Y. The plurality of conductive contacts 203 of the first flexible cable 200A and the plurality of conductive contacts 203 of the second flexible cable 200B are disposed at opposite sides of the slot in the vertical direction Z-Z. As will be described in detail below, a mating portion, such as the tongue portion of the electrical connector 20, may be inserted between the second segment 220 of the first flexible cable 200A and the second segment 220 of the second flexible cable 200B, e.g., may be inserted into the slot.

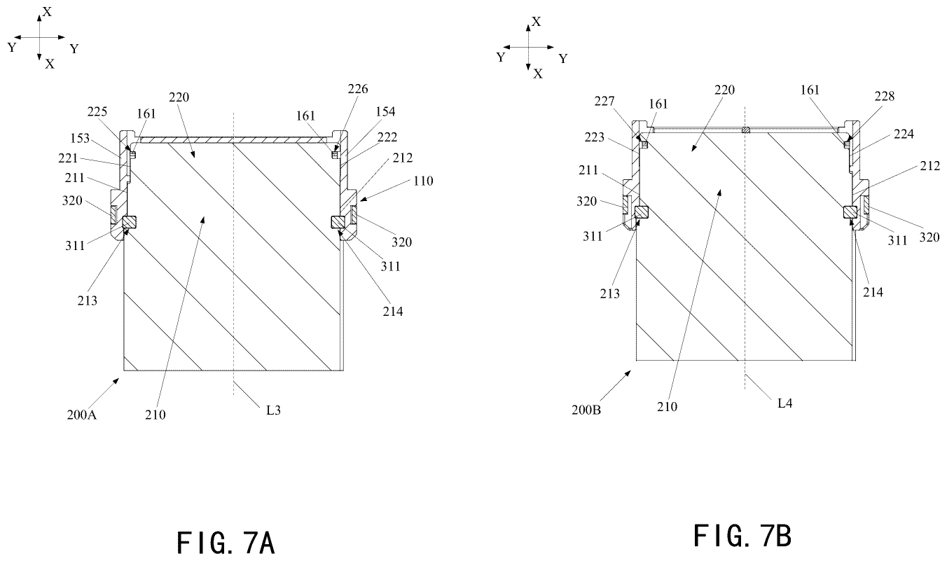

The second segment 220 of each of the first flexible cable 200A and the second flexible cable 200B has a side edge. For example, as shown in FIGS. 4B, 4E, and 7A, the second segment 220 of the first flexible cable 200A includes a first side edge 221 and a second side edge 222 opposite to each other in the longitudinal direction Y-Y. As shown in FIG. 7B, similar to the first flexible cable 200A, the second segment 220 of the second flexible cable 200B includes a third side edge 223 and a fourth side edge 224 opposite to each other in the longitudinal direction Y-Y.

In some embodiments, the second segment 220 of each of the first flexible cable 200A and the second flexible cable 200B may include a notch recessed into the second segment 220 from a side edge thereof in the longitudinal direction Y-Y. The insulative housing 100 may further include a plurality of beams extending from the base portion 110 into the accommodation space 140 in the lateral direction X-X, and each beam may include a bulge. When the first flexible cable 200A and the second flexible cable 200B are disposed in position in the insulative housing 100, the bulge of each of the plurality of beams engages a notch of the second segment 220 of a corresponding one of the first flexible cable 200A and the second flexible cable 200B, so as to hold the second segment 220 in the accommodation portion 150.

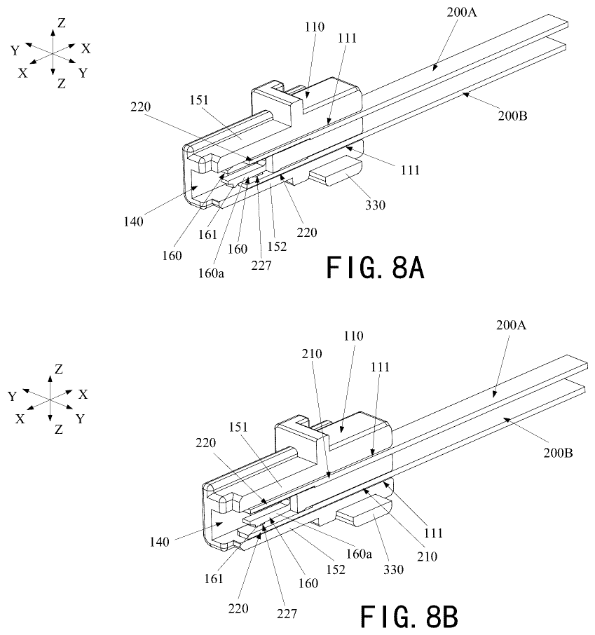

For example, as shown in FIGS. 4B, 4E, and 7A, the second segment 220 of the first flexible cable 200A may include a first notch 225 recessed into the second segment 220 from the first side edge 221 in the longitudinal direction Y-Y, and a second notch 226 recessed into the second segment 220 from the second side edge 222 in the longitudinal direction Y-Y. As shown in FIGS. 7B and 8A to 8B, the second segment 220 of the second flexible cable 200B may include a third notch 227 recessed into the second segment 220 from the third side edge 223 in the longitudinal direction Y-Y, and a fourth notch 228 recessed into the second segment 220 from the fourth side edge 224 in the longitudinal direction Y-Y.

As shown in FIGS. 8A and 8B, the insulative housing 100 may include a plurality of beams 160 extending into the accommodation space 140 from the base portion 110 in the lateral direction X-X. FIG. 8A illustrates the first flexible cable 200A and the second flexible cable 200B being inserted into the insulative housing 100, but not locked by the beams 160 of the insulative housing 100. FIG. 8B illustrates the first flexible cable 200A and the second flexible cable 200B disposed in position in the insulative housing 100 and locked by the beams 160.

For example, each beam 160 includes a bulge 161. The beam 160 may be a flexible arm. The bulge 161 may be in the shape of a barb. The plurality of beams 160 may include a first group, which in this embodiment includes two beams 160, only one of the two beams 160 is shown in FIG. 8A. As shown in FIG. 8A, the first group of beams 160 extend from the base portion 110 in the lateral direction X-X and between the second segment 220 of the first flexible cable 200A and the second segment 220 of the second flexible cable 200B. Each beam 160 of the first group is configured to engage with a corresponding one of the first notch 225 and the second notch 226 of the second segment 220 of the first flexible cable 200A. As shown in FIGS. 7A and 8B, when the first flexible cable 200A is disposed in position in the insulative housing 100, the bulges 161 of the two beams 160 engage with the first notch 225 and the second notch 226 of the second segment 220 of the first flexible cable 200A, respectively, to hold the second segment 220 of the first flexible cable 200A in the accommodation space 140.

The plurality of beams 160 may further include a second group, which in this embodiment includes two beams 160, only one of the two beams 160 is shown in FIG. 8A. Similar to the first group, as shown in FIG. 8A, the second group of beams 160 also extend from the base portion 110 in the lateral direction X-X and between the second segment 220 of the first flexible cable 200A and the second segment 220 of the second flexible cable 200B. Each beam 160 of the second group is configured to engage with a corresponding one of the third notch 227 and the fourth notch 228 of the second segment 220 of the second flexible cable 200B. As shown in FIGS. 7B and 8B, when the second flexible cable 200B is disposed in position in the insulative housing 100, the bulges 161 of the two beams 160 engage with the third notch 227 and the fourth notch 228 of the second segment 220 of the second flexible cable 200B, respectively, to hold the second segment 220 of the second flexible cable 200B in the accommodation space 140.

With such a configuration, the connecting ends 202 of the first flexible cable 200A and the second flexible cable 200B can be pre-locked in the insulative housing 100, prior to the locking of the connecting ends 202 with the latching member 300, thereby facilitating the operation of the latching member 300 to lock the connecting ends 202. Furthermore, such a configuration reliably holds the second segments 220 of the first flexible cable 200A and the second flexible cable 200B in the insulative housing 100. For example, when the electrical connector 10 is mated with the electrical connector 20, such a configuration can prevent the second segments 220 of the first flexible cable 200A and the second flexible cable 200B from shifting or buckling, thereby increasing the reliability of the electrical connector 10.

As illustrated in FIGS. 8A and 8B, each of the plurality of beams 160 may include a third body 160a. The bulge 161 protrudes from the third body 160a in the vertical direction Z-Z. The second wall 152 and the third bodies 160a of the beams 160 of the second group of beams 160 clamp the side edges of the second segment 220 of the second flexible cable 200B therebetween. With such a configuration, it is possible to guide the insertion of the second segments 220 of the second flexible cable 200B into the accommodation portion 150. Furthermore, the second segment 220 of the second flexible cable 200B can be reliably held in the accommodation space 140. It can be appreciated that the first wall 151 and the third bodies 160a of the beams 160 of the first group can clamp the side edges of the second segment 220 of the first flexible cable 200A therebetween. With such a configuration, it is possible to guide the insertion of the second segment 220 of the first flexible cable 200A into the accommodation portion 150. Furthermore, the second segment 220 of the first flexible cable 200A can be reliably held in the accommodation portion 150.

In some embodiments, as shown in FIG. 7A, the profile of the first side edge 221 and the profile of the second side edge 222 of the first flexible cable 200A are asymmetric about the center line L3 of the second segment 220. Such a configuration can provide a fool-proof function to prevent the first flexible cable 200A from being inserted into the accommodation space 140 in an improper orientation (in which the plurality of conductive contacts 203 of the first flexible cable 200A face towards the first wall 151).

In some embodiments, as shown in FIG. 7B, the profile of the third side edge 223 and the profile of the fourth side edge 224 of the second flexible cable 200B are asymmetric about the center line L4 of the second segment 220. Such a configuration can provide a fool-proof function to prevent the second flexible cable 200B from being inserted into the accommodation space 140 in an improper orientation (in which the plurality of conductive contacts 203 of the second flexible cable 200B face towards the second wall 152).

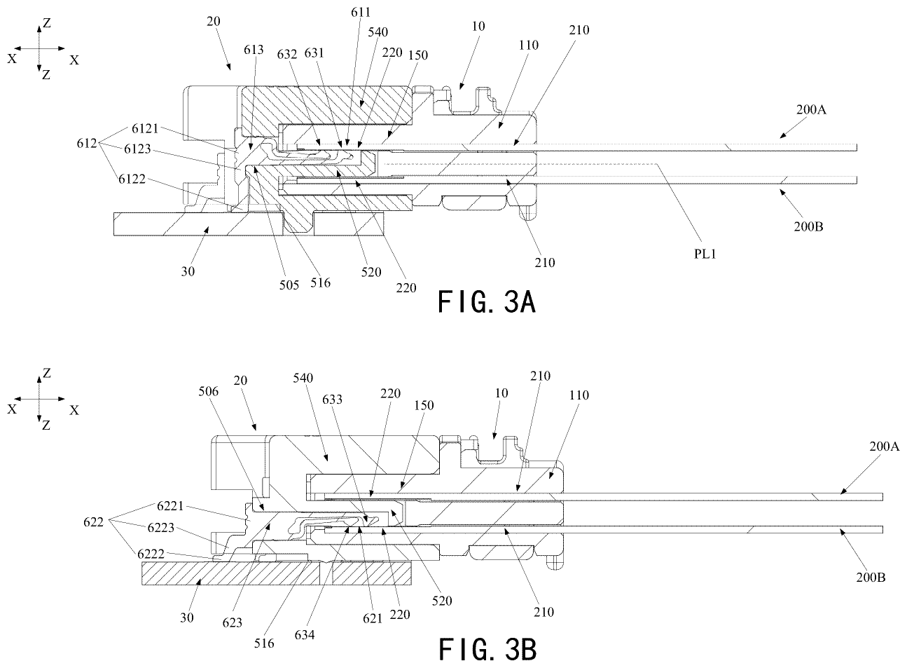

In some embodiments, as shown in FIG. 3A, the first segment 210 of the first flexible cable 200A and the first segment 210 of the second flexible cable 200B are parallel with each other and may bound a midplane PL1 therebetween. As shown in FIG. 7A, the first side edge 211 and the second side edge 212 of the first segment 210 of the first flexible cable 200A may bound a first outer profile of the first flexible cable 200A. As shown in FIG. 7B, the first side edge 211 and the second side edge 212 of the first segment 210 of the second flexible cable 200B may bound a second outer profile of the second flexible cable 200B. The first outer profile of the first flexible cable 200A and the second outer profile of the second flexible cable 200B are asymmetric about the midplane PL1. Such a configuration can provide a fool-proof function to prevent the first flexible cable 200A and the second flexible cable 200B from being inserted into the incorrect first channels 111.

As shown in FIGS. 4A and 4B, the first wall 151 and the third wall 153 of the insulative housing 100 are connected to each other at a first corner, the first wall 151 and the fourth wall 154 are connected to each other at a second corner, the second wall 152 and the third wall 153 are connected to each other at a third corner, and the second wall 152 and the fourth wall 154 are connected to each other at a fourth corner.

In some embodiments, the accommodation portion 150 of the insulative housing 100 may include a first rib 171 protruding outward from the first wall 151 at the first corner in the vertical direction Z-Z, and a second rib 172 protruding outward from the first wall 151 at the second corner in the vertical direction Z-Z. The first rib 171 and the second rib 172 extend in the lateral direction X-X, respectively. As will be described in detail below, the first rib 171 and the second rib 172 are configured to cooperate with corresponding grooves of the housing of the electrical connector 20 when the accommodation portion 150 of the insulative housing 100 is inserted into the housing of the electrical connector 20, so as to guide the insertion of the insertion portion. Such a configuration can prevent the electrical connector 10 from being inserted into the housing of the electrical connector 20 in a skewed orientation, thereby providing protection to the mating conductive structures of the electrical connector 10 and the electrical connector 20, and improving the hot-plugging ability of the electrical connector 10. Alternatively or additionally, the insulative housing 100 may include ribs at the third corner and the fourth corner.

In some embodiments, as shown in FIGS. 4A and 4D, the third wall 153 of the insulative housing 100 may extend beyond the first wall 151 and the second wall 152 in the lateral direction X-X to form a first protrusion 173, and the fourth wall 154 may extend beyond the first wall 151 and the second wall 152 in the lateral direction X-X to form a second protrusion 174. As will be described in detail below, the first protrusion 173 and the second protrusion 174 are configured to mate with corresponding recesses of the housing of the electrical connector 20 when the accommodation portion 150 of the insulative housing 100 is inserted into the housing of the electrical connector 20. Such a configuration can increase the size of the accommodation portion 150 in the mating direction without increasing the overall width of the electrical connector 10 and the electrical connector 20. When the accommodation portion 150 of the electrical connector 10 is inserted into the housing of the electrical connector 20, such a configuration can guide the accommodation portion 150 in the proper orientation and reduce the amount of wobble thereof, thereby increasing the hot-plugging ability of the electrical connector 10. Furthermore, if the accommodation portion 150 of the electrical connector 10 is inserted into the housing of the electrical connector 20 in a skewed orientation, such a configuration can prevent the conductive portions of the electrical connector 10 and the electrical connector 20 from contacting each other to protect the circuit from damage. This can improve the hot-plugging ability and reliability of the electrical connector 10.

FIG. 4F is a perspective view similar to FIG. 4A, which illustrates another embodiment of the electrical connector 10. For example, the electrical connector 10 shown in FIG. 4F differs from the electrical connector 10 shown in FIG. 4A only in that the accommodation portion 150 of the insulative housing 100 of the electrical connector 10 shown in FIG. 4F includes a reinforcing rib 175. The reinforcing rib 175 is provided at the middle of the front end of the accommodation portion 150 and extends between the first wall 151 and the second wall 152. Such a configuration can increase the strength of the accommodation portion 150 and can protect the accommodation portion 150 from deforming. The reinforcement rib 175 may be integrally formed with the accommodation portion 150.

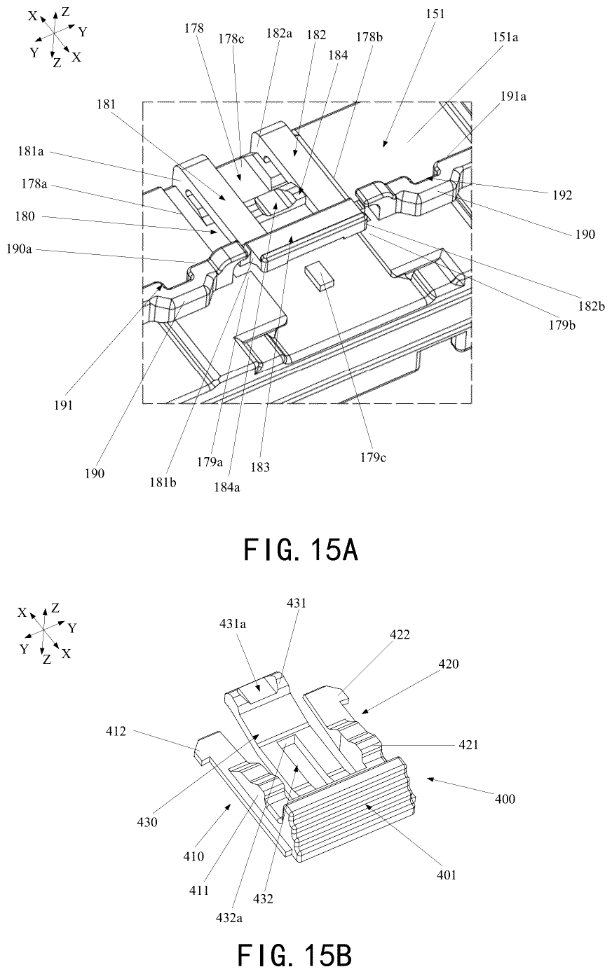

In some embodiments, as shown in FIGS. 4A, 4F, 15A, and 15B, the electrical connector 10 may include a connector position assurance (CPA) device configured to lock the electrical connector 10 to a mating electrical connector (e.g., electrical connector 20) when the electrical connector 10 is mated with the mating electrical connector.

As shown in FIG. 15A, the accommodation portion 150 may include a groove 178 that is recessed into the first wall 151 from the outer surface 151a of the first wall 151 in the vertical direction Z-Z and extends in the lateral direction X-X. The groove 178 may extend to the base portion 110 in the lateral direction X-X. The groove 178 may include a bottom wall 178c and a first sidewall 178a and a second sidewall 178b opposite to each other in the longitudinal direction Y-Y. The groove 178 may further include a first protrusion 179a protruding from the first sidewall 178a of the groove 178 in the longitudinal direction Y-Y, a second protrusion 179b protruding from the second sidewall 178b of the groove 178 in the longitudinal direction Y-Y, and a third protrusion 179c protruding from the bottom wall 178c of the groove 178 in the vertical direction Z-Z.

Continuing to refer to FIG. 15A, the CPA device may include an overhanging component 180. The overhanging component 180 may be an integral portion of the accommodation portion 150. The overhanging component 180 may include a first resilient beam 181 and a second resilient beam 182. The first resilient beam 181 and the second resilient beam 182 extend from the bottom wall 178c towards the base portion 110 in the lateral direction X-X, respectively. The first resilient beam 181 and the second resilient beam 182 may be cantilever beams. The first resilient beam 181 includes a first end 181a and a second end 181b opposite to each other in the lateral direction X-X. The first end 181a is configured to be fixed and connected to the bottom wall 178c. The second end 181b is configured to be unfixed and spaced apart from the bottom wall 178c in the vertical direction Z-Z. The second resilient beam 182 includes a first end 182a and a second end 182b opposite to each other in the lateral direction X-X. The first end 182a is configured to be fixed and connected to the bottom wall 178c. The second end 182b is configured to be unfixed and spaced apart from the bottom wall 178c in the vertical direction Z-Z. The first resilient beam 181 and the second resilient beam 182 are spaced apart from each other in the longitudinal direction Y-Y and may bound a receiving space therebetween. The first resilient beam 181 and the second resilient beam 182 may be parallel with each other.

The overhanging component 180 may further include a third beam 183 and a fourth beam 184. The third beam 183 extends from the second end 181b of the first elastic beam 181 to the second end 182b of the second elastic beam 182 in the longitudinal direction Y-Y. For example, the third beam 183 connects the second end 181b of the first elastic beam 181 to the second end 182b of the second elastic beam 182. The fourth beam 184 may also extend in the longitudinal direction Y-Y and include a first end and a second end (which are not labeled) opposite to each other in the longitudinal direction Y-Y. The first end of the fourth beam 184 is connected to the first resilient beam 181 between the first end 181a and the second end 181b of the first resilient beam 181, and the first end of the fourth beam 184 is connected to the second resilient beam 182 between the first end 182a and the second end 182b of the second resilient beam 182. The third beam 183 and the fourth beam 184 may be parallel with each other. As will be described in detail below, the fourth beam 184 is configured to engage with a mating bulge of a mating electrical connector (e.g., the electrical connector 20) when the electrical connector 10 is mated with the mating electrical connector, thereby locking the electrical connector 10 to the mating electrical connector.

In some embodiments, as shown in FIGS. 4A, 4B, 4F, and 15B, the CPA device may further include the latching member 400. The latching member 400 may be configured to lock the fourth beam 184 in a position where the fourth beam 184 engages with a mating bulge of the mating electrical connector (e.g., the electrical connector 20) when the electrical connector 10 is mated with the mating electrical connector, thereby ensuring that the electrical connector 10 is reliably locked to the mating electrical connector. The latching member 400 may be referred to as “a second latching member.” The latching member 400 may be formed from an insulative material. Examples of insulative materials suitable for forming the latching member 400 include, but are not limited to, plastic, nylon, liquid crystal polymer (LCP), polyphenylene sulfide (PPS), high temperature nylon or polyphenylenoxide (PPO) or polypropylene (PP)

The latching member 400 may be configured to be disposed in the groove 178 and capable of being moved in the groove 178 between a first position (FIG. 4F) and a second position (FIG. 4A) relative to the overhanging component 180 in the lateral direction X-X. As shown in FIG. 15B, the latching member 400 may include a base body 401 and a first resilient arm 410 and a second resilient arm 420 extending from the base body 401 in the lateral direction X-X, respectively. The base body 401 may be shaped to facilitate engagement by a user's hand to move the latching member 400 in the groove 178. The first resilient arm 410 and the second resilient arm 420 are opposite to each other and spaced apart from each other in the longitudinal direction Y-Y. The first resilient arm 410 and the second resilient arm 420 may be configured to engage with the first sidewall 178a and the second sidewall 178b of the groove 178, respectively, to hold the latching member 400 in the groove 178. The first resilient arm 410 may include a first protrusion 411 protruding in the vertical direction Z-Z and a second protrusion 412 protruding in the lateral direction X-X, and the second resilient arm 420 may include a first protrusion 421 protruding in the vertical direction Z-Z and a second protrusion 422 protruding in the lateral direction X-X. The second protrusions 412 and 422 may each be in the shape of a barb. The latching member 400 may further include a third resilient arm 430. The third resilient arm 430 extends from the base body 401 obliquely in the lateral direction X-X and has a protrusion 431 at an end opposite to the base body 401. The third resilient arm 430 may also be formed with a slide groove 432, which extends in the lateral direction X-X and includes a first end 432a (FIG. 15B) and a second end 432b (FIG. 4A) opposite to each other in the lateral direction X-X. The third resilient arm 430 may be between the first resilient arm 410 and the second resilient arm 420 in the longitudinal direction Y-Y.

As shown in FIGS. 4A, 4F, 15A, and 15B, when the latching member 400 is disposed in the groove 178, the first resilient arm 410 and the second resilient arm 420 may engage with the first sidewall 178a and the second sidewall 178b of the groove 178, respectively, to hold the latching member 400 in the groove 178. The third resilient arm 430 of the latching member 400 may extend obliquely from the base body 401 in the lateral direction X-X into the receiving space bounded by the first resilient beam 181 and the second resilient beam 182 of the overhanging component 180 to enable the protrusion 431 to be positioned in the receiving space. The second protrusion 412 of the first resilient arm 410 and the second protrusion 422 of the second resilient arm 420 of the latching member 400 may cooperate with the first protrusion 179a and the second protrusion 179b of the groove 178, respectively, and the slide groove 432 of the third resilient arm 430 of the latching member 400 may cooperate with the third protrusion 179c of the groove 178 to bound the range of movement of the latching member 400 in the groove 178 in the lateral direction X-X.

As shown in FIGS. 4A, 15A, and 15B, when the latching member 400 is placed in the second position, the second protrusion 412 of the first resilient arm 410 and the second protrusion 422 of the second resilient arm 420 of the latching member 400 may engage with the first protrusion 179a and the second protrusion 179b of the groove 178 (alternative or additionally, the first end 432a of the slide groove 432 of the third resilient arm 430 may engage with the third protrusion 179c), respectively, to limit the movement of the latching member 400 away from the overhanging component 180 in the lateral direction X-X. Furthermore, the first protrusion 411 of the first resilient arm 410 and the first protrusion 421 of the second resilient arm 420 do not engage with the first resilient beam 181 and the second resilient beam 182 below the first resilient beam 181 and the second resilient beam 182, and the protrusion 431 of the third resilient arm 430 is positioned between the fourth beam 184 and the third beam 183, thereby unlocking the overhanging component 180, so as to enable the third beam 183 and the fourth beam 184 of the overhanging component 180 to move towards the bottom wall 178c when biased towards the bottom wall 178c. In this case, biasing the third beam 183 towards the bottom wall 178c can move the third beam 183 and the fourth beam 184 towards the bottom wall 178c. This can cause the fourth beam 184 to disengage from the bulge of the mating connector when the electrical connector 10 is mated with the mating connector.

As shown in FIGS. 4F, 15A, and 15B, the second protrusion 412 of the first resilient arm 410 and the second protrusion 422 of the second resilient arm 420 of the latching member 400 may be disengaged from the first protrusion 179a and the second protrusion 179b of the groove 178, respectively, when the latching member 400 is placed in the first position. The second end 432b of the slide groove 432 of the third resilient arm 430 may engage with the third protrusion 179c to limit the movement of the latching member 400 towards the overhanging component 180 in the lateral direction X-X. Furthermore, the first protrusion 411 of the first resilient arm 410 and the first protrusion 421 of the second resilient arm 420 of the latching member 400 may engage with the first resilient beam 181 and the second resilient beam 182 below the first resilient beam 181 and the second resilient beam 182, respectively, and the protrusion 431 of the third resilient arm 430 is positioned to engage with the fourth beam 184 on a side of the fourth beam 184 opposite to the third beam 183, thereby locking the overhanging component 180 to prevent the third beam 183 and the fourth beam 184 from moving towards the bottom wall 178c when biased towards the bottom wall 178c. In this case, biasing the third beam 183 towards the bottom wall 178c cannot cause the third beam 183 and the fourth beam 184 to move towards the bottom wall 178c. This ensures that the fourth beam 184 is in reliable engagement with the bulge of the mating connector when the electrical connector 10 is mated with the mating connector.

With such a configuration, the latching member 400 can be selectively placed in a pre-locked position (the second position shown in FIG. 4A) and a locked position (the first position shown in FIG. 4F). In the pre-locked position, the latching member 400 is reliably held on the insulative housing 100 and unlocks the overhanging component 180 to enable the third beam 183 and the fourth beam 184 of the overhanging component 180 to move towards the bottom wall 178c when biased towards the bottom wall 178c. In the locked position, the latching member 400 is also reliably held on the insulative housing 100 and locks the overhanging component 180 to prevent the third beam 183 and fourth beam 184 from moving towards the bottom wall 178c when biased towards the bottom wall 178c. Such a configuration can enable the electrical connector 10 to meet the requirements of a specification such as USCAR. As the latching member 400 can be pre-locked into position, loss of the latching member 400 can be avoided when the electrical connector 10 is mated with the mating connector, and the assembly efficiency of the electronic system 1 can be improved.

A method of operating the overhanging component 180 and the latching member 400 to lock the electrical connector 10 to the electrical connector 20 and to unlock the electrical connector 10 from the electrical connector 20 will be described below in connection with an example of combining the electrical connector 10 with the electrical connector 20 into a connector assembly.

In some embodiments, the first end 181a of the first resilient beam 181 and the first end 182a of the second resilient beam 182 of the overhanging component 180 may be reinforced by, e.g., including additional portions such as the reinforcing portion 185 shown in FIG. 4A, thereby increasing the reliability of the overhanging component 180.

Although the electrical connector 10 is described above as having two flexible cables, it should be appreciated that the present application may not be limited thereto. In some embodiments, the electrical connector 10 may include more (e.g., three, four, five) flexible cables. The structure of the insulative housing 100 may be adapted accordingly for disposing more flexible cables. For example, the insulative housing 100 may have more first channels 111.

Although the latching member 300 is described above as being configured to selectively engage with the side edges of the flexible cable to achieve pre-locking and locking functions, it should be appreciated that the present application may not be limited thereto. The latching member 300 may be any suitable type of latching member adapted to hold the connecting ends of the flexible cables in the insulative housing.

Although the latching member 300 is described above as having two first arms 310, it should be appreciated that the present application may not be limited thereto. In some embodiments, the latching member 300 may have only a single first arm 310, or may have more than two first arms 310. The number of the second channels of the insulative housing 100 and the number of the notches of the flexible cables may be adapted accordingly. For example, the flexible cable may have a plurality of notches at each side edge, or only have one or more notches at a single side edge.

Although the latching member 300 is described above as having two second arms 320, it should be appreciated that the present application may not be limited thereto. In some embodiments, the latching member 300 may have only a single second arm 320. For example, the latching member 300 has a single first arm 310 and a single second arm 320 to achieve the pre-locking and locking functions described above. In some embodiments, the latching member 300 may have more than two second arms 320. The number of slots of the insulative housing 100 may be adapted accordingly.

### Receptacle Connector

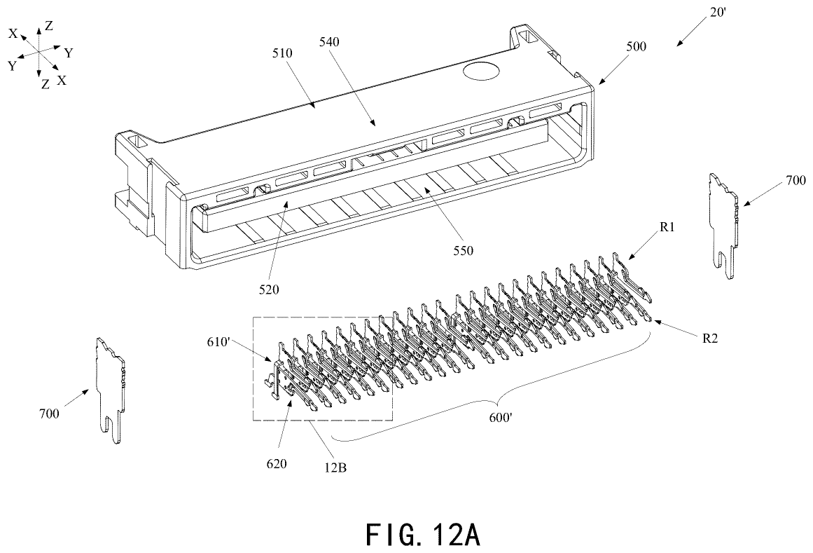

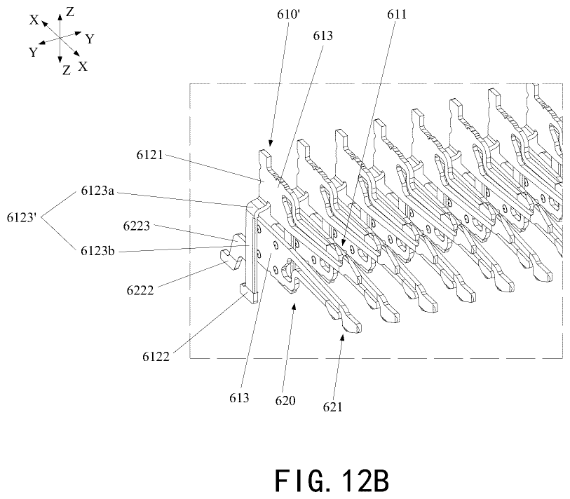

FIGS. 9A to 14 illustrate the receptacle connector, in which FIGS. 9A to 11 illustrate a first embodiment of the receptacle connector labeled as the electrical connector 20, and FIGS. 12A to 14 illustrate a second embodiment of the receptacle connector labeled as the electrical connector 20′.

As shown in FIGS. 9A and 9B, the electrical connector 20 may include an insulative housing 500, a plurality of conductive elements 600, and a hold-down tab 700.

The plurality of conductive elements 600 are disposed in the insulative housing 500. The insulative housing 500 provides support and protection to the plurality of conductive elements 600. The insulative housing 500 may be formed from an insulative material. Examples of insulative materials suitable for forming the insulative housing 500 include, but are not limited to, plastic, nylon, liquid crystal polymer (LCP), polyphenylene sulfide (PPS), high temperature nylon or polyphenylenoxide (PPO) or polypropylene (PP).

The electrical connector 20 may be configured to be disposed on the surface 31 of the circuit board 30 and electrically connected to the conductive structures (e.g., the conductive pads 32 in FIG. 1C) of the circuit board 30. The insulative housing 500 may be configured to be placed on the surface 31 of the circuit board 30. The insulative housing 500 may include slots 530 for receiving hold-down tabs 700. As shown in FIGS. 1A and 1B, the hold-down tabs 700 may be inserted into the corresponding slots 530 and secure the insulative housing 500 on the circuit board 30. The hold-down tab 700 may be formed from a metallic material.

As shown in FIGS. 9A to 9E and FIG. 11, the insulative housing 500 may include a base portion 510 and a tongue portion 520 extending from the base portion 510 in the lateral direction X-X. The tongue portion 520 extends from a first surface (front surface) 511 of the base portion 510 in the lateral direction X-X. The tongue portion 520 may include a first surface 521 and a second surface 522 opposite to each other in the vertical direction Z-Z perpendicular to the lateral direction X-X. The base portion 510 may include a top surface 515 and a bottom surface 516 opposite to each other in the vertical direction Z-Z. When the electrical connector 20 is mounted on the circuit board 30, the bottom surface 516 of the base portion 510 faces towards the surface 31 of the circuit board, and the second surface 522 of the tongue portion 520 is closer to the surface 31 of the circuit board 30 and the bottom surface 516 of the base portion 510 in the vertical direction Z-Z than the first surface 521.

The conductive element 600 may be formed from a conductive material. The conductive material suitable for forming the conductive element 600 may be a metallic material, such as a copper alloy. The conductive element may be referred to as “a terminal,” “a conductor,” or “a conductive element.”

Each conductive element 600 includes a mating end having a mating contact portion, a tail end opposite to the mating end, and an intermediate portion joining the mating end and the tail end. For example, as shown in FIG. 9B, the plurality of conductive elements 600 may include a plurality of first conductive elements 610 and a plurality of second conductive elements 620. The plurality of first conductive elements 610 are arranged in a first row R1 in the longitudinal direction Y-Y perpendicular to the lateral direction X-X and the vertical direction Z-Z. In the first row R1, the plurality of first conductive elements 610 are aligned with and spaced apart from each other in the longitudinal direction Y-Y. The plurality of second conductive elements 620 are arranged in a second row R2 in the longitudinal direction Y-Y. In the second row R2, the plurality of second conductive elements 620 are aligned with and spaced apart from each other in the longitudinal direction Y-Y. The first row R1 and the second row R2 may be spaced apart from each other in the vertical direction Z-Z. The first row R1 may be disposed above the second row R2 in the vertical direction Z-Z (relative to the surface 31 of the circuit board 30). The first row R1 may be referred to as “a top row,” and the first conductive element 610 may be referred to as “an upper conductive element.” The second row R2 may be referred to as “a bottom row,” and the second conductive element 620 may be referred to as “a lower conductive element.”

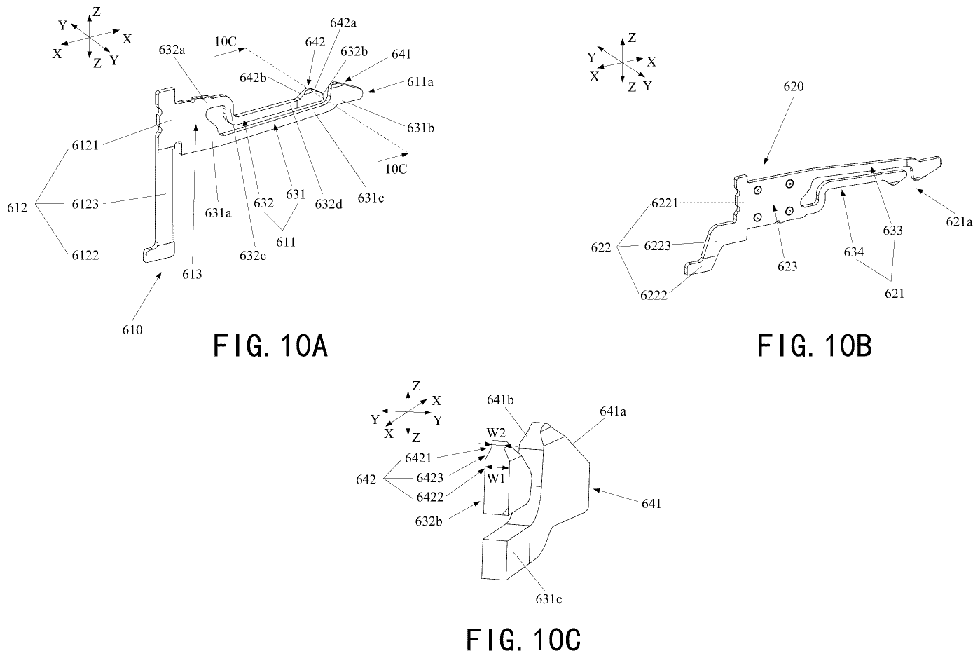

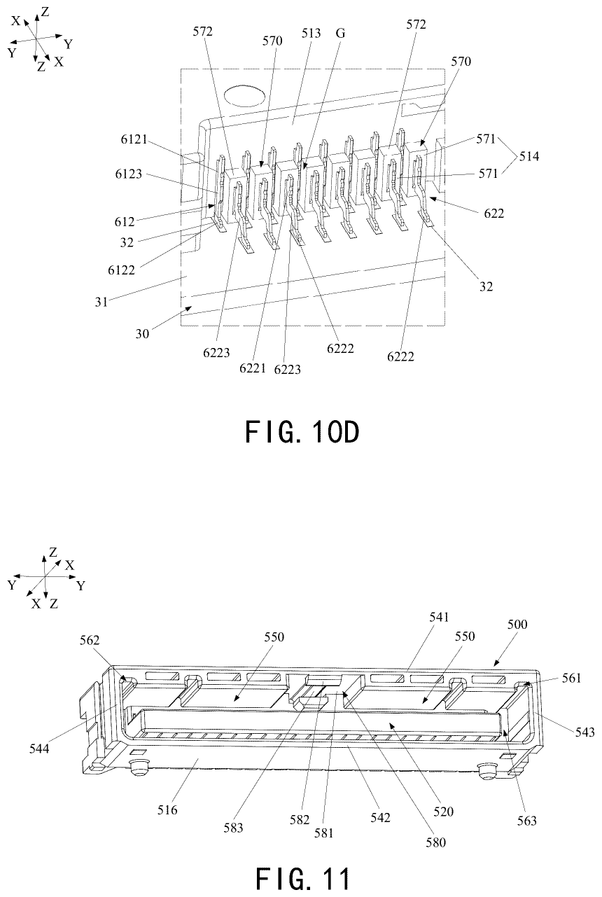

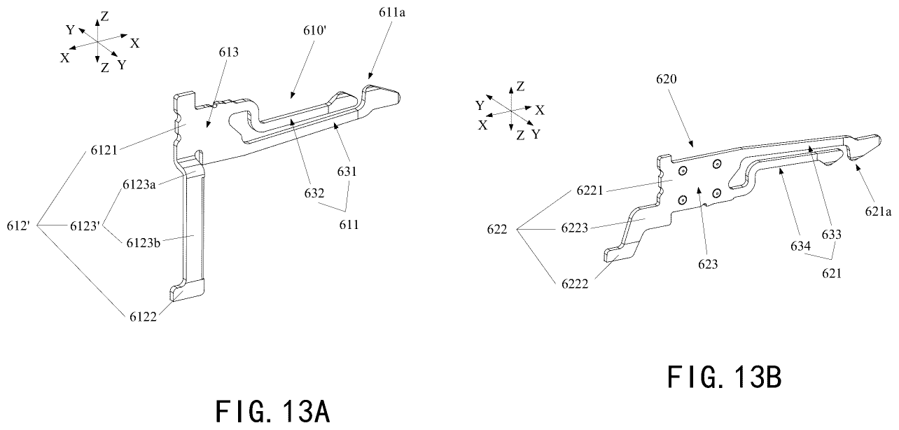

FIGS. 10A and 10B illustrate configurations of the first conductive element 610 and the second conductive element 620, respectively. As shown in FIG. 10A, the first conductive element 610 includes a mating end 611 having a mating contact portion 611a, a tail end 612 opposite to the mating end, and an intermediate portion 613 joining the mating end 611 and the tail end 612. As shown in FIG. 10B (or FIG. 13B), the second conductive element 620 includes a mating end 621 having a mating contact portion 621a, a tail end 622 opposite to the mating end 621, and an intermediate portion 623 joining the mating end 621 and the tail end 622.

As shown in FIGS. 3A to 3B, 9A, 9C, and 9D, the insulative housing 500 may include a plurality of first channels 505 and a plurality of second channels 506 extending from the base portion 510 into the tongue portion 520 in the lateral direction X-X. Each first channel 505 may extend into the tongue portion 520 from a first side of the base portion 510 opposite to the tongue portion 520 in the lateral direction X-X and is open at the first surface 521 of the tongue portion 520. Each second channel 506 may extend from the first side of the base portion 510 into the tongue portion 520 in the lateral direction X-X and is open at the second surface 522 of the tongue portion 520. The intermediate portion 613 and the mating end 611 of each of the plurality of first conductive elements 610 are inserted into the corresponding first channel 505 from the first side of the base portion 510, the intermediate portion 613 is disposed in the base portion 510, and the mating end 611 extends into the tongue portion 520 with the mating contact portion 611a protruding from the first surface 521. Similarly, the intermediate portion 623 and the mating end 621 of each of the plurality of second conductive elements 620 are inserted into the corresponding second channel 506 from the first side of the base portion 510, the intermediate portion 623 is disposed in the base portion 510, and the mating end 621 extends into the tongue portion 520 with the mating contact portion 621a protruding from the second surface 522. With such a configuration, as will be described in detail below, when the electrical connector 10 is mated with the electrical connector 20, the mating contact portions 611a of the plurality of first conductive elements 610 can establish a separable electrical contact with the plurality of conductive contacts 203 of the first flexible cable 200A of the electrical connector 10, and the mating contact portions 621a of the plurality of second conductive elements 620 can establish a separable electrical contact with the plurality of second conductive contacts 203 of the second flexible cable 200B of the electrical connector 10.

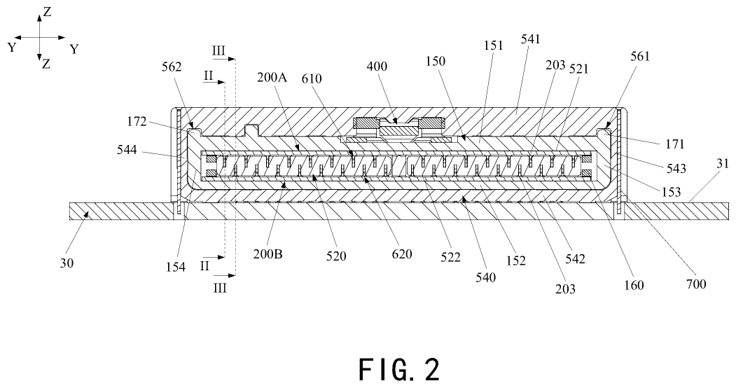

As shown in FIGS. 2 and 9A, the mating ends 611 of the plurality of first conductive elements 610 and the mating ends 621 of the plurality of second conductive elements 620 may be offset from each other in the vertical direction Z-Z. Such an arrangement can enable the first row R1 and the second row R2 to be arranged at a smaller spacing in the vertical direction Z-Z, while still ensuring sufficient spacing between the mating ends 611 of the first conductive elements 610 and the mating ends 621 of the second conductive elements 620. Such an arrangement can reduce the size (e.g., height) of the electrical connector 20 in the vertical direction Z-Z. This facilitates miniaturization of the electrical connector 20 and can reduce a footprint of the electrical connector 20 on the circuit board 30.

In some embodiments, as shown in FIG. 10A, for each first conductive element 610, the mating end 611 may include a first beam 631 and a second beam 632, and the first beam 631 and the second beam 632 extend from the intermediate portion 613 in the lateral direction X-X in a plane perpendicular to the longitudinal direction Y-Y. For example, the first beam 631 and the second beam 632 may be coplanar with each other. The first beam 631 and the second beam 632 are spaced apart from each other in the vertical direction Z-Z. The first beam 631 has a first contact portion 641 and the second beam 632 has a second contact portion 642. The first beam 631 is longer than the second beam 632 in the lateral direction X-X to enable the first contact portion 641 of the first beam 631 and the second contact portion 642 of the second beam 632 to be aligned with and spaced apart from each other in the lateral direction X-X. The first contact portion 641 of the first beam 631 is farther away from the intermediate portion 613 of the first conductive element 610 in the lateral direction X-X than the second contact portion 642 of the second beam 632. As shown in FIG. 9D, when the first conductive element 610 is disposed in the insulative housing 500, the first contact portion 641 of the first beam 631 and the second contact portion 642 of the second beam 632 protrude from the first surface 521 and are aligned with and spaced apart from each other in the lateral direction X-X, and the first contact portion 641 of the first beam 631 is closer to a front end 520a of the tongue portion 520 opposite to the base portion 510 than the second contact portion 642 of the second beam 632. The first beam 631 and the second beam 632 may be resilient beams. The first contact portion 641 of the first beam 631 and the second contact portion 642 of the second beam 632 together constitute the mating contact portion 611a of the mating end 611 of the first conductive element 610.

Such a double-beam-and-contact configuration of the first conductive element 610 can improve the reliability of the electrical connection of the electrical connector 20 and effectively prevent transient breakage. Furthermore, such a configuration of the first conductive element 610 can improve the current-carrying capacity of the first conductive element 610, thereby enabling the electrical connector 20 to meet the demand for transmitting large currents. In addition, such a configuration of the first conductive element 610 can improve the contact density of the electrical connector 20, thereby facilitating the miniaturization of the electrical connector 20.

As shown in FIG. 10A, the first beam 631 of each first conductive element 610 includes a first end 631a and a second end 631b opposite to each other, and a first straight segment 631c joining the first end 631a and the second end 631b. The first end 631a is connected to the intermediate portion 613, and the second end 631b is configured to be unfixed. For example, the first beam 631 is a cantilever beam. The first straight segment 631c extends obliquely from the first end 631a relative to the lateral direction X-X towards the second beam 632 to the second end 631b. The first contact portion 641 of the first beam 631 is located at the second end 631b and protrudes from the first straight segment 631c in the vertical direction Z-Z.

Continuing to refer to FIG. 10A, the second beam 632 of each first conductive element 610 includes a third end 632a and a fourth end 632b opposite to each other, a curved segment 632c extending from the third end 632a, and a second straight segment 632d joining the curved segment 632c and the fourth end 632b. The third end 632a is connected to the intermediate portion 613, and the fourth end 632b is configured to be unfixed. For example, the second beam 632 is a cantilever beam. The curved segment 632c of the second beam 632 is curved from the third end 632a towards the first beam 631 so that the second straight segment 632d and the fourth end 632b are located between the intermediate portion 613 of the first conductive element 610 and the second end 631b of the first beam 631 in the lateral direction X-X. The second straight segment 632d extends from the curved segment 632c to the fourth end 632b. The second contact portion 642 is located at the fourth end 632b and protrudes from the second straight segment 632d in the vertical direction Z-Z.

With such a configuration, the first beam 631 can prevent the second beam 632 from excessive deformation to protect the second beam 632, when the second beam 632 is biased to deflect towards the first beam 631 in the vertical direction Z-Z. Further, the shapes of the first beam 631 and the second beam 632 of the first conductive element 610 can provide a longer force arm in a limited space, thereby improving the consistency of the contact forces provided by the first beam 631 and the second beam 632.

As shown in FIGS. 10A and 10C, for each first conductive element 610, the first contact portion 641 of the first beam 631 has a convex shape and includes a first leading surface 641a (which is adjacent to the front end 520a of the tongue portion 520 in the lateral direction X-X when the first conductive element 610 is disposed in the insulative housing 500) and a first trailing surface 641b (which is away from the front end 520a of the tongue portion 520 in the lateral direction X-X when the first conductive element 610 is disposed in the insulative housing 500). The first leading surface 641a may be formed as an inclined leading surface. Such a structure can guide the insertion of the first flexible cable 200A when the electrical connector 10 is mated with the electrical connector 20, thereby preventing the first contact portion 641 and the conductive contact 203 from damage due to excessive mating force. Alternatively or additionally, the first trailing surface 641b may be formed as an inclined guiding surface. Such a structure can guide the withdrawal of the first flexible cable 200A when the electrical connector 10 is disengaged from the electrical connector 20, thereby preventing the first contact portion 641 and the conductive contact 203 from damage due to excessive un-mating force.

Alternatively or additionally, as shown in FIG. 10A, similar to the first contact portion 641 of the first beam 631, the second contact portion 642 of the second beam 632 may have a convex shape and include a second leading surface 642a (which is adjacent to the front end 520a of the tongue portion 520 in the lateral direction X-X when the first conductive element 610 is disposed in the insulative housing 500) and a second trailing surface 642b (which is away from the front end 520a of the tongue portion 520 in the lateral direction X-X when the first conductive element 610 is disposed in the insulative housing 500). The second leading surface 642a may be formed as an inclined leading surface. Such a structure can guide the insertion of the first flexible cable 200A when the electrical connector 10 is mated with the electrical connector 20, thereby preventing the second contact portion 642 and the conductive contact 203 from damage due to excessive mating force. Alternatively or additionally, the second trailing surface 642b may be formed as an inclined guiding surface. Such a structure can guide the withdrawal of the first flexible cable 200A when the electrical connector 10 is disengaged from the electrical connector 20, thereby preventing the second contact portion 642 and the conductive contacts 203 from damage due to excessive un-mating force.

In some embodiments, as illustrated in FIG. 10C, the second contact portion 642 of the second beam 632 has a convex shape and includes a first end segment 6421 and a second end segment 6422 opposite to each other in the vertical direction Z-Z, and a transition segment 6423 joining the first end segment 6421 and the second end segment 6422. The first end segment 6421 is connected to the fourth end 632b of the second beam 632 and has a constant first width W1 in the longitudinal direction Y-Y. The second end segment 6422 has a constant second width W2 in the longitudinal direction Y-Y. The second width W2 is less than the first width W1. The cross section of the transition segment 6423 perpendicular to the lateral direction X-X has an isosceles trapezoidal shape, and the transition segment 6423 has a width in the longitudinal direction Y-Y tapering from the first width W1 to the second width W2. Alternatively or additionally, the shape of the first contact portion 641 of the first beam 631 may be similar to that of the second contact portion 642 of the second beam 632. For the sake of brevity, details of similar parts may not be repeated. The shape of the first contact portion 641 of the first beam 631 and the shape of the second contact portion 642 of the second beam 632 can improve the contact reliability of the first conductive element 610 and can be conveniently machined to have sufficient strength.

In some embodiments, as shown in FIG. 10B, similar to the first conductive element 610, the second conductive element 620 may have a double-beam-and-contact configuration. For example, the configuration of the mating end 621 of the second conductive element 620 may be similar to that of the mating end 611 of the first conductive element 610. The mating end 621 of the second conductive element 620 may include a third beam 633 and a fourth beam 634. The third beam 633 and the fourth beam 634 extend from the intermediate portion 613 in the lateral direction X-X in a plane perpendicular to the longitudinal direction Y-Y, and are spaced apart from each other in the vertical direction Z-Z. The shapes of the third beam 633 and the fourth beam 634 may be similar to those of the first beam 631 and the second beam 632, respectively. Furthermore, the arrangements of the third beam 633 and the fourth beam 634 may be similar to those of the first beam 631 and the second beam 632. For the sake of brevity, details of similar parts may not be repeated.

The double-contact configuration of the first conductive element 610 and the second conductive element 620 can provide more contact locations in a limited space, thus enabling the electrical connector 20 to meet high pin count requirements.

It should be appreciated that the configurations of the mating portions of the first conductive element 610 and the second conductive element 620 may not be limited to the configurations described above. In some embodiments, the mating ends 621 of the first conductive element 610 and the second conductive element 620 may each have a single beam and a single contact, or have more beams and more contacts.

As shown in FIGS. 9A to 9E and 11, the insulative housing 500 further includes an accommodation portion 540 extending from the first surface 511 of the base portion 510 in the lateral direction X-X and enclosing an accommodation space 550. The tongue portion 520 is positioned in the accommodation space 550. The accommodation space 550 is open at an end opposite to the base portion 510. With such a configuration, the mating ends 621 of the first conductive element 610 and the second conductive element 620 can be positioned in the accommodation space 550 and protected by the accommodation portion 540 from being touched by a user's finger or by a tool, thereby preventing the user from getting electric shock or avoiding a circuit short. Such a configuration can improve the safety and reliability of the electronic system 1 utilizing the electrical connector 20.

For example, the front end 520a of the tongue portion 520 may be indented into the accommodation space 550 by a distance in the lateral direction X-X relative to the opening of the accommodation portion 540. The distance may be, for example, greater than or equal to 1 mm.

The accommodation portion 540 of the insulative housing 500 may include a first wall 541 and a second wall 542 opposite to each other and spaced apart from each other in the vertical direction Z-Z, and a third wall 543 and a fourth wall 544 opposite to each other and spaced apart from each other in the longitudinal direction Y-Y. The first wall 541 and second wall 542 may be referred to as top and bottom walls, respectively. The third wall 543 and fourth wall 544 may be referred to as sidewalls. The first wall 541, the second wall 542, the third wall 543, and the fourth wall 544 enclose the accommodation space 550. The accommodation space 550 may be used as a slot of the insulative housing 500 to receive a housing of another electrical connector that mates with the electrical connector 20. For example, the accommodation space 550 may receive the accommodation portion 150 of the insulative housing 100 of the electrical connector 10.

As shown in FIGS. 9A and 9B, the first wall 541 and the third wall 543 of the insulative housing 500 are connected to each other at a first corner, the first wall 541 and the fourth wall 544 are connected to each other at a second corner, the second wall 542 and the third wall 543 are connected to each other at a third corner, and the second wall 542 and the fourth wall 544 are connected to each other at a fourth corner.

In some embodiments, the accommodation portion 540 of the insulative housing 500 may include a first groove 561 recessed into the first wall 541 from the accommodation space 550 in the vertical direction Z-Z at the first corner, and a second groove 562 recessed into the first wall 541 from the accommodation space 550 in the vertical direction Z-Z at the second corner. The first groove 561 and the second groove 562 extend in the lateral direction X-X, respectively. The first groove 561 and the second groove 562 are configured to receive the first rib 171 and the second rib 172 of the insulative housing 100 of the electrical connector 10, respectively. With such a configuration, only the first rib 171 and the second rib 172 of the insulative housing 100 are aligned with the first groove 561 and the second groove 562 in the lateral direction X-X, respectively, the accommodation portion 150 of the insulative housing 100 of the electrical connector 10 is inserted into the accommodation space 550 of the accommodation portion 540 of the insulative housing 500 of the electrical connector 20. Such a configuration can prevent the electrical connector 10 from being inserted into the housing of the electrical connector 20 in a skewed orientation, thereby providing protection to the mating conductive structures of the electrical connector 10 and the electrical connector 20, and improving the hot-plugging ability of the electrical connector 20. Furthermore, during insertion of the accommodation portion 150 into the accommodation space 550 of the accommodation portion 540, the first groove 561 and the second groove 562 can serve to guide the insertion. In addition, the cooperation of the first rib 171 and the second rib 172 with the first groove 561 and the second groove 562 can ensure the electrical connector 10 to be inserted into the electrical connector 20 in a unique orientation. Alternatively or additionally, the insulative housing 500 may include grooves at the third corner and the fourth corner.

As shown in FIG. 9A, the tongue portion 520 may be spaced apart from the third wall 543 and the fourth wall 544 in the lateral direction X-X, respectively, and may be spaced apart from the first wall 541 and the second wall 542 in the vertical direction Z-Z, respectively. When the accommodation portion 150 of the insulative housing 100 of the electrical connector 10 is inserted into the accommodation space 550 of the accommodation portion 540 of the insulative housing 500 of the electrical connector 20, the first wall 151 of the insulative housing 100 and the first flexible cable 200A are positioned between the tongue portion 520 and the first wall 541, the second wall 152 of the insulative housing 100 and the second flexible cable 200B are positioned between the tongue portion 520 and the second wall 542, the third wall 153 of the insulative housing 100 is positioned between the tongue portion 520 and the third wall 543, and the fourth wall 154 of the insulative housing 100 is positioned between the tongue portion 520 and the fourth wall 544.

In some embodiments, as shown in FIGS. 9A and 9E, the insulative housing 500 may include a first recess 563 and a second recess 564 recessed into the first surface 511 of the base portion 510 in the lateral direction X-X from the accommodation space 550 at opposite ends of the tongue portion 520 in the longitudinal direction Y-Y, respectively. The first recess 563 and the second recess 564 are configured to receive the first protrusion 173 and the second protrusion 174 of the insulative housing 100 of the electrical connector 10, respectively. Such a configuration can increase the size of the accommodation portion 150 in the mating direction without increasing the overall width of the electrical connector 10 and the electrical connector 20. When the accommodation portion 150 of the electrical connector 10 is inserted into the housing of the electrical connector 20, such a configuration can guide the accommodation portion 150 in the proper orientation and reduce the amount of wobble thereof, thereby increasing the hot-plugging ability of the electrical connector 10. Furthermore, if the accommodation portion 150 of the electrical connector 10 is inserted into the housing of the electrical connector 20 in a skewed orientation, such a configuration can prevent the conductive portions of the electrical connector 10 and the electrical connector 20 from contacting each other to protect the circuit from damage. This can improve the hot-plugging ability and reliability of the electrical connector 10.

In some embodiments, as shown in FIGS. 1C and 10D, the base portion 510 may include a third surface 513 and a fourth surface 514 at a side opposite to the tongue portion 520. Both the third surface 513 and the fourth surface 514 are perpendicular to the lateral direction X-X and face towards the same direction. The fourth surface 514 is farther away from the tongue portion 520 in the lateral direction X-X than the third surface 513. For example, the third surface 513 and the fourth surface 514 are spaced apart from each other in the lateral direction X-X. The tail ends 612 of the plurality of first conductive elements 610 extend from the third surface 513 of the base portion 510 in the lateral direction X-X, and the tail ends 622 of the plurality of second conductive elements 620 extend from the fourth surface 514 of the base portion 510 in the lateral direction X-X. For example, the tail ends 612 of the plurality of first conductive elements 610 and the tail ends 622 of the plurality of second conductive elements 620 protrude from different reference surfaces of the base portion 510 spaced apart in the lateral direction X-X. In other words, the tail ends 612 of the plurality of first conductive elements 610 and the tail ends 622 of the plurality of second conductive elements 620 are inserted into the base portion 510 from different reference surfaces of the base portion 510 spaced apart in the lateral direction X-X.

Such a configuration can increase the creepage distances between the tail ends 612 of the plurality of first conductive elements 610 and the tail ends 622 of the plurality of second conductive elements 620, thereby enabling the plurality of first conductive elements 610 and the plurality of second conductive elements 620 to be arranged at tighter spacing, and increasing the dielectric withstanding voltage performance of the electrical connector 20. This enables to reduce the size of the electrical connector 20 in the lateral direction X-X and/or the longitudinal direction Y-Y. This facilitates miniaturization of the electrical connector 20 and enables reduction of the footprint of the electrical connector 20 on the circuit board 30.

In some embodiments, as shown in FIGS. 1C and 10D, the base portion 510 may include a plurality of protrusions 570 protruding from the third surface 513 in the lateral direction X-X. The plurality of protrusions 570 are aligned with and spaced apart from each other in the longitudinal direction Y-Y. Each protrusion 570 includes a rear face 571, and the rear face 571 is parallel with the third surface 513 and faces towards the same direction as the third surface 513. As the protrusion 570 protrudes from the third surface 513, the rear face 57 of the protrusion 570 is spaced apart from the third surface 513 in the lateral direction X-X, and the rear face 57 of the protrusion 570 is farther away from the tongue portion 520 than the third surface 513 in the lateral direction X-X. The rear faces 571 of the plurality of protrusions 570 may be coplanar. Every adjacent two of the plurality of protrusions 570 may bound a gap G therebetween in the longitudinal direction Y-Y. Each protrusion 570 also has a side face 572 facing away from a plane in which the bottom surface 516 of the base portion 510 extends.

The fourth surface 514 of the base portion 510 includes the rear faces 571 of the plurality of protrusions 570. For example, the fourth surface 514 of the base portion 510 is a discontinuous surface that may be formed collectively by the rear faces 571 of the plurality of protrusions 570. The tail end 622 of each of the plurality of second conductive elements 620 extends from the rear face 571 of a corresponding one of the plurality of protrusions 570 of the base portion 510 in the lateral direction X-X. As described above, the tail ends 612 of the plurality of first conductive elements 610 extend from the third surface 513 of the base portion 510 in the lateral direction X-X. For example, the tail ends 612 of the plurality of first conductive elements 610 and the tail ends 622 of the plurality of second conductive elements 620 protrude from different reference surfaces of the base portion 510 spaced apart in the lateral direction X-X. With such a configuration, the creepage distances between the tail ends 612 of the plurality of first conductive elements 610 and the tail ends 622 of the plurality of second conductive elements 620 can be increased.

In some embodiments, the electrical connector 20 is a right angle connector. For the plurality of conductive elements 600, the tail end of each conductive element includes a first segment extending from the intermediate portion in the lateral direction X-X and out of the base portion 510, a second segment configured to be mounted to the circuit board 30, and a third segment joining the first segment and the second segment. The third segment extends from the first segment towards the plane in which the bottom surface 516 of the base portion 510 extends to enable the second segment to be mounted to the circuit board 30.

For example, as shown in FIGS. 10A and 10D, the tail end 612 of each first conductive element 610 includes a first segment 6121, a second segment 6122, and a third segment 6123 joining the first segment 6121 and the second segment 6122. The first segment 6121 extends from the intermediate portion 613 in the lateral direction X-X and out of the third surface 513 of the base portion 510 of the insulative housing 500. The second segment 6122 is configured to be mounted to the circuit board 30. The second segment 6122 may be referred to as “a mounting portion.” As shown in FIGS. 10B and 10D, the tail end 622 of each second conductive element 620 includes a first segment 6221, a second segment 6222, and a third segment 6223 joining the first segment 6221 and the second segment 6222. The first segment 6221 extends from the intermediate portion 623 in the lateral direction X-X to protrude from the base portion 510 of the insulative housing 500. The second segment 6222 is configured to be mounted to the circuit board 30. The second segment 6222 may be referred to as “a mounting portion.”

In some embodiments, as shown in FIG. 10D, the third segment 6123 of the tail end 612 of each of the plurality of first conductive elements 610 extends through the gap G between two corresponding adjacent protrusions 570 in the vertical direction Z-Z so that the third segments 6123 of every two adjacent first conductive elements 610 are separated by the protrusion 570. For example, the third segment 6123 of each first conductive element 610 may be a straight segment. Although a portion of the third segment 6123 of the first conductive element 610 is shown in FIG. 10D as extending through the gap G in the vertical direction Z-Z, it should be appreciated that In some embodiments, the entire length of the third segment 6123 of the first conductive element 610 may be located in the gap G. Thus, in the present application, at least a portion of the third segment 6123 of the first conductive element 610 may extend through the gap G between two corresponding adjacent protrusions 570 in the vertical direction Z-Z.

Such a configuration can increase the creepage distances between the tail ends 612 of the plurality of first conductive elements 610 and the tail ends 622 of the plurality of second conductive elements 620, thereby enabling the plurality of first conductive elements 610 and the plurality of second conductive elements 620 to be arranged at tighter spacing, and increasing the dielectric withstanding voltage performance of the electrical connector 20. This enables to reduce the size of the electrical connector 20 in the lateral direction X-X and/or the longitudinal direction Y-Y. This facilitates miniaturization of the electrical connector 20 and enables reduction of the footprint of the electrical connector 20 on the circuit board 30.

In some embodiments, as shown in FIG. 10D, the first segment 6121 and the third segment 6123 of the first conductive element 610 do not extend beyond the rear face 571 of the protrusion 570 in the lateral direction X-X.

In some embodiments, as shown in FIG. 10D, the conductive structures on the circuit board 30 configured for establishing electrical connections with the conductive elements may be conductive pads 32. In this case, the second segment of the tail end of each of the plurality of conductive elements 600 may be configured to be mounted to the conductive pad 32 of the circuit board 30. The mounting surfaces of the second segments 6122 of the tail ends 612 of the plurality of first conductive elements 610 and the mounting surfaces of the second segments 6222 of the tail ends 622 of the plurality of second conductive elements 620 may be coplanar in a plane perpendicular to the vertical direction Z-Z. The second segments 6122 of the tail ends 612 of the plurality of first conductive elements 610 are arranged in a row in the longitudinal direction Y-Y, and the second segments 6222 of the tail ends 622 of the plurality of second conductive elements 620 are arranged in a row in the longitudinal direction Y-Y. The second segments 6122 of the plurality of first conductive elements 610 are closer to the third surface 513 than the second segments 6222 of the plurality of second conductive elements 620. The second segments 6122 of the plurality of first conductive elements 610 and the second segments 6222 of the plurality of second conductive elements 620 may be offset from each other in the lateral direction X-X. Such a configuration can facilitate flatness inspection after the second segments 6122 and 6222 of the mounting terminals 612 and 622 are mounted to the conductive pads 32 of the circuit board 30.

As shown in FIGS. 9A and 9B, the intermediate portions 613 of the plurality of first conductive elements 610 and the intermediate portions 623 of the plurality of second conductive elements 620 may be offset from each other in the vertical direction Z-Z. Such a configuration enables the first row R1 and the second row R2 to be arranged at a smaller spacing in the vertical direction Z-Z, while still ensuring sufficient spacing between the intermediate portions 613 of the first conductive elements 610 and the intermediate portions 623 of the second conductive elements 620. In this way, the size (e.g., height) of the electrical connector 20 in the vertical direction Z-Z can be reduced. This facilitates miniaturization of the electrical connector 20 and enables reduction of the footprint of the electrical connector 20 on the circuit board 30.

In some embodiments, as shown in FIG. 11, the accommodation portion 540 of the insulative housing 500 may include a groove 580. The groove 580 is recessed into the first wall 541 from the accommodation space 550 in the vertical direction Z-Z and extends in the lateral direction X-X. The groove 580 includes a bottom wall 581. The accommodation portion 540 may further include a bulge 582 protruding from the bottom wall 581 of the groove 580 into the groove 580. As will be described in detail below, the bulge 582 may be configured to be engaged by the fourth beam 184 of the electrical connector 10. The bulge 582 may be disposed proximate to a front edge of the first wall 541. The bulge 582 may be integrally formed with the first wall 541.

In some embodiments, as shown in FIG. 11, the accommodation portion 540 of the insulative housing 500 may include a reinforce rib 583. The reinforce rib 583 may protrude into the groove 580 from the bottom wall 581 of the groove 580 and extend in the lateral direction X-X. The reinforce rib 583 can increase the strength of a wall segment of the first wall 541 corresponding to the groove 580. As the reinforce rib 583 can provide sufficient strength to the wall segment of the first wall 541, the wall segment may not be bent outward in a convex shape as the conventional housing. This facilitates the reduction of the height of the electrical connector 20 in the vertical direction Z-Z, thereby facilitating the miniaturization of the electrical connector 20.

Referring to FIGS. 15A and 15B, the fourth beam 184 of the overhanging component 180 of the insulative housing 100 of the electrical connector 10 may include a first notch 184a extending through the fourth beam 184 in the lateral direction X-X, and the protrusion 431 of the third resilient arm 430 of the latching member 400 may include a second notch 431a extending through the protrusion 431 in the lateral direction X-X. As shown in FIG. 4A, the first notch 184a and the second notch 431a are aligned with each other in the lateral direction X-X when the latching member 400 is placed in the second position. This enables the reinforce rib 583 to extend through the first notch 184a and the second notch 431a in the lateral direction X-X when the electrical connector 10 and the electrical connector 20 are mated. Such a configuration of the first notch 184a, the second notch 431a, and the reinforce rib 583 can further reduce the height of the electrical connector 20 in the vertical direction Z-Z.

Although the intermediate portions and mating ends of the conductive elements 600 are described above as being inserted directly into the channels of the insulative housing 500, it should be appreciated that the present application may not be limited thereto. In some embodiments, the insulative housing 500 may be molded around the intermediate portions and mating ends of the conductive elements 600, or the conductive elements 600 may be held by an insulative terminal retention member, and the conductive elements 600 and the terminal retention member together constitute a terminal assembly and are mounted to the insulative housing 500.

Although the tail ends of the conductive elements are described above as being configured to be mounted to the conductive pads 32 of the circuit board 30, it should be appreciated that the present application may not be limited thereto. In other embodiments, the tail ends may be in any other suitable form, such as a press fit “needle eye.”

Although the fourth surface 514 of the base portion 510 is described as being formed from discontinuous surfaces, it should be appreciated that the present application may not be limited thereto. In some embodiments, the fourth surface 514 of the base portion 510 may be a continuous surface. Furthermore, in the case where the conductive elements 600 are held by an insulative terminal retention member, the terminal retention member is a part of the base portion 510, and thus the surface of the terminal retention member is a surface of the base portion 510.

The configuration of the electrical connector 20′ is described in detail below with reference to FIGS. 12A to 14. As shown in FIGS. 12A to 14, the electrical connector 20′ may be substantially the same in configuration as the electrical connector 20. Thus, the same reference signs are used in FIGS. 12A to 14 to denote portions of the electrical connector 20′ that may be similar to the electrical connector 20 shown in FIGS. 9A to 11, and details of those same or similar portions will not be repeated herein.

As shown in FIG. 12A, similar to the electrical connector 20, the electrical connector 20′ may include an insulative housing 500, a plurality of conductive elements 600′, and a hold-down tab 700. The insulative housing 500 and the hold-down tab 700 of the electrical connector 20′ may be substantially similar to the insulative housing 500 and the hold-down tab 700 of the electrical connector 20, respectively. For the sake of brevity, details of these same or similar portions will not be repeated herein.

As shown in FIGS. 12A to 14, the configuration and arrangement of the plurality of conductive elements 600′ of the electrical connector 20′ are different from those of the plurality of conductive elements 600 of the electrical connector 20.

For example, as shown in FIGS. 12A to 13B, the plurality of conductive elements 600′ includes a plurality of first conductive elements 610′ and a plurality of second conductive elements 620. The configuration of the second conductive element 620 of the electrical connector 20′ may be similar to that of the second conductive element 620 of the electrical connector 20. For the sake of brevity, details of these same portions will not be repeated herein.

Referring to FIGS. 12A to 13B, the first conductive element 610′ of the electrical connector 20′ includes a mating end 611 having a mating contact portion 611a, a tail end 612′ opposite to the mating end, and an intermediate portion 613 joining the mating end 611 and the tail end 612. The shapes of the mating end 611 and the intermediate portion 613 of the first conductive element 610′ of the electrical connector 20′ may be similar to those of the mating end 611 and the intermediate portion 613 of the first conductive element 610 of the electrical connector 20. For the sake of brevity, details of these same portions will not be repeated herein.

Similar to the tail end 612 of the first conductive element 610, the tail end 612′ of the first conductive element 610′ includes a first segment 6121, a second segment 6122, and a third segment 6123′ joining the first segment 6121 and the second segment 6122. The first segment 6121 extends from the intermediate portion 613 in the lateral direction X-X and out of the base portion 510 of the insulative housing 500. The second segment 6122 is configured to be mounted to the circuit board 30. The third segment 6123′ extends from the first segment 6121 towards a plane in which the bottom surface 516 of the base portion 510 extends to enable the second segment 6122 to be mounted to the circuit board 30. The shapes of the first segment 6121 and the second segment 6122 of the tail end 612′ of the first conductive element 610′ may be similar to those of the first segment 6121 and the second segment 6122 of the tail end 612 of the first conductive element 610. For the sake of brevity, details of these same portions will not be repeated herein.

The shape of the third segment 6123′ of the tail end 612′ of the first conductive element 610′ may differ from that of the third segment 6123 of the tail end 612 of the first conductive element 610. For example, as illustrated in FIG. 13A, the third segment 6123′ of the first conductive element 610′ may be a curved segment and may include a first segment 6123a extending from the first segment 6121 in the longitudinal direction Y-Y, and a second segment 6123b extending from the first segment 6122 to the second segment 6122 in the vertical direction Z-Z. Such shape of the third segment 6123′ enables the second segment 6122 to be offset from the first segment 6121 in the lateral direction X-X and the vertical direction Z-Z. For example, the second segment 6122 and the first segment 6121 of the tail end 612′ extend along different planes perpendicular to the longitudinal direction Y-Y and spaced apart from each other in the longitudinal direction Y-Y, respectively. Such shape of the third segment 6123′ enables the second conductive element 620 to be disposed directly below the first conductive element 610′ in such a manner that the mating end 621 of the second conductive element 620 and the mating end 611 of the first conductive element 610′ are aligned with each other in the vertical direction Z-Z.

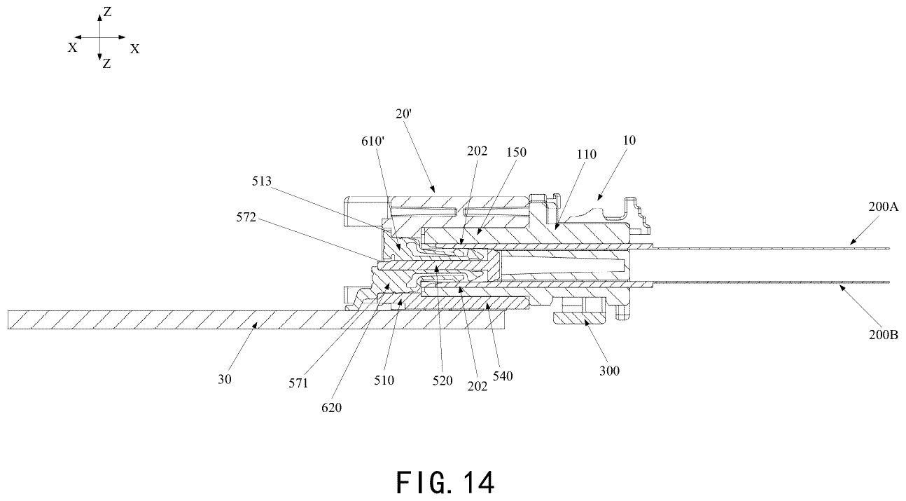

FIGS. 12A, 12B, and 14 illustrate the relative positions of the first conductive elements 610′ and the second conductive elements 620 of the electrical connector 20′ when disposed in the insulative housing 500. As shown in FIGS. 12A, 12B, and 14, the intermediate portion 613 of each of the plurality of first conductive elements 610′ and the intermediate portion 613 of a corresponding one of the plurality of second conductive elements 620 are aligned with each other in the vertical direction Z-Z. Furthermore, the mating end 611 of each of the plurality of first conductive elements 610′ and the mating end 621 of a corresponding one of the plurality of second conductive elements 620 are aligned with each other in the vertical direction Z-Z.

At the side of the base portion 510 opposite to the tongue portion 520, the first segment 6121 of the tail end 612′ of each first conductive element 610′ extends out of the third surface 513 of the base portion 510 in the lateral direction X-X above the side 572 (FIGS. 10D and 14) of a corresponding one of the plurality of protrusions 570. The first segment 6123a of the third segment 6123′ of the tail end 612′ extends along the side 572 (e.g., extends adjacently to the side 572) in the longitudinal direction Y-Y, and the second segment 6123b extends through the gap G (FIG. 10D) between the corresponding two adjacent protrusions 570 to the second segment 6122 in the vertical direction Z-Z.

Such a configuration can increase the creepage distances between the tail ends 612′ of the plurality of first conductive elements 610′ and the tail ends 622 of the plurality of second conductive elements 620 of the electrical connector 20′, thereby enabling the tail ends 612′ of the plurality of first conductive elements 610′ and the tail ends 622 of the plurality of second conductive elements 620 to be arranged at tighter spacing and to improve the dielectric withstanding voltage performance of the electrical connector 20′. This enables to reduce the size of the electrical connector 20′ in the lateral direction X-X and/or the longitudinal direction Y-Y. This facilitates miniaturization of the electrical connector 20′ and enables reduction of the footprint of the electrical connector 20′ on the circuit board 30. In addition, such a configuration can enable the mating ends 611 of the plurality of first conductive elements 610′ and the mating ends 621 of the plurality of second conductive elements 620 to be aligned with each other in the vertical direction Z-Z.

In some embodiments, the first segments 6121 and the third segments 6123′ (including the first segments 6123a and the second segments 6123b) of the tail ends 612′ of the first conductive elements 610′ do not extend beyond the rear faces 571 of the protrusions 570 in the lateral direction X-X.

The other configurations, variants, functions and advantages of the electrical connector 20′ are identical to those of the electrical connector 20. For the sake of brevity, details of these same portions will not be repeated herein.

### Connector Assembly

The electrical connector 10 and the electrical connector 20 may be mated with each other to form a connector assembly. Such a connector assembly can provide an electrical connection between the circuit board 3 and another electrical component for achieving signal and/or power transmission. Such a connector assembly may be referred to as “a wire-to-board assembly” or “a wire-to-board connector.” Such a connector assembly may be used, for example, as a BMS connector in a battery management system.

As shown in FIGS. 1A to 3B, when the electrical connector 10 and the electrical connector 20 are mated with each other, the tongue portion 520 of the electrical connector 20 is received in the insulative housing 100 of the electrical connector 10 and is positioned between the connecting end 202 of the first flexible cable 200A and the connecting end 202 of the second flexible cable 200B, so that the mating contact portions of the mating ends of the plurality of conductive elements 600 are in electrical contact with the plurality of conductive contacts 203 of the first flexible cable 200A and the plurality of conductive contacts 203 of the second flexible cable 200B. For example, the mating contact portions 611a of the mating ends 611 of the plurality of first conductive elements 610 are in electrical contact with the plurality of conductive contacts 203 of the first flexible cable 200A, and the mating contact portions 621a of the mating ends 621 of the plurality of second conductive elements 620 are in electrical contact with the plurality of conductive contacts 203 of the second flexible cable 200B. In this way, it is possible to establish electrical connections between the flexible cables of the electrical connector 10 and the conductive elements 600 of the electrical connector 20. When the electrical connector 20 is mounted on the circuit board 30, the conductive elements 600 of the electrical connector 20 can establish electrical connections between the flexible cables of the electrical connector 10 and the conductive structures on the circuit board 30, thereby connecting the flexible cable to the circuit board 30.

As illustrated in FIG. 2, the tongue portion 520 of the insulative housing 500 of the electrical connector 20 is received in the accommodation space 140 of the insulative housing 100 of the electrical connector 10 and is positioned between the second segment 220 of the first flexible cable 200A and the second segment 220 of the second flexible cable 200B of the electrical connector 10. The accommodation portion 150 of the insulative housing 100 of the electrical connector 10 is received in the accommodation portion 540 of the insulative housing 500 of the electrical connector 20 and is positioned between the tongue portion 520 and the accommodation portion 540 of the insulative housing 500 of the electrical connector 20. Such an arrangement enables the insulative housing 100 of the electrical connector 10 and the insulative housing 500 of the electrical connector 20 to be tightly mated together and to form a labyrinth sealing protection between the exterior of the connector assembly and the mating interface of the connector assembly, so as to effectively prevent foreign matter from entering to the mating interface.

The first wall 151 of the electrical connector 10 and the second segment 220 of the first flexible cable 200A are received between the first wall 541 and the tongue portion 520 of the electrical connector 20. The second wall 152 of the electrical connector 10 and the second segment 220 of the second flexible cable 200B are received between the second wall 542 and the tongue portion 520 of the electrical connector 20. The third wall 153 of the electrical connector 10 is received between the third wall 543 and the tongue portion 520 of the electrical connector 20. The fourth wall 154 of the electrical connector 10 is received between the fourth wall 544 and the tongue portion 520 of the electrical connector 20.

As shown in FIG. 2, the first rib 171 and the second rib 172 of the electrical connector 10 are received in the first groove 561 and the second groove 562 of the electrical connector 20, respectively. As described above, such a configuration can improve the hot-plugging ability of the connector assembly.

The first protrusion 173 and the second protrusion 174 of the electrical connector 10 are received in the first recess 563 and the second recess 564 of the electrical connector 20, respectively. As described above, such a configuration can improve the hot-plugging ability and reliability of the connector assembly.

The first resilient beam 181 and the second resilient beam 182 of the overhanging component 180 of the CPA device of the electrical connector 10 extend into the groove 580 of the accommodation portion 540 of the electrical connector 20 so that the fourth beam 184 is positioned in the groove 580. The bulge 582 of the accommodation portion 540 is positioned between the fourth beam 184 and the third beam 183 of the overhanging component 180 and engages with the fourth beam 184. In this case, as described above, the latching member 400 can be selectively placed in the pre-locked position (the second position shown in FIG. 4A) and the locked position (the first position shown in FIG. 4F) to unlock and lock the overhanging component 180. The first notch 184a of the fourth beam 184 can be aligned with the reinforce rib 583 in the lateral direction X-X so that the reinforce rib 583 extends through the first notch 184a in the lateral direction X-X. Further, the first notch 184a and the second notch 431a are aligned with each other in the lateral direction X-X when the latching member 400 is placed in the locked position. In this case, both the first notch 184a and the second notch 431a are aligned with the reinforce rib 583 in the lateral direction X-X so that the reinforce rib 583 extends through the first notch 184a and the second notch 431a in the lateral direction X-X.

The electrical connector 10 may be configured to be capable for being un-mated from the electrical connector 20 by manual operation when the electrical connector 10 and the electrical connector 20 are mated with each other. In some embodiments, as shown in FIG. 16B, the base portion 110 of the insulative housing 100 of the electrical connector 10 may have an engagement protrusion 188 at an end thereof opposite to the accommodation portion 150. The engagement protrusion 188 is configured to be capable of being grasped by a user's hand so as to facilitate moving the electrical connector 10 away from the electrical connector 20. The user may first place the latching member 400 in the second position to unlock the overhanging component 180, subsequently press the third beam 183 of the overhanging component 180 towards the bottom wall 178c, and grasp the engagement protrusion 188 to move the electrical connector 10 away from the electrical connector 20, thereby disengaging the electrical connector 10 from the electrical connector 20.

Alternatively or additionally, the electrical connector 10 is configured to be capable for being manipulated by a tool to un-mate from the electrical connector 20 when the electrical connector 10 and the electrical connector 20 are mated with each other. For example, as shown in FIGS. 15A and 16A, the insulative housing 100 may include a flange portion 190 protruding outwardly from the base portion 110 in the vertical direction Z-Z. As shown in FIG. 1B, when the electrical connector 10 and the electrical connector 20 are mated with each other, the flange portion 190 abuts against a front edge 541a of the first wall 541 of the accommodation portion 540 in the lateral direction X-X. The flange portion 190 includes a first side 190a facing towards the front edge 541a of the first wall 541, and a first receiving recess 191 and a second receiving recess 192 recessed into the flange portion 190 from the first side 190a in the lateral direction X-X.

An exemplary tool 800 is illustrated in FIGS. 16A to 16E. As shown in FIGS. 16A to 16C, the tool 800 may include a tool body 810 and a first leg 811, a second leg 812, and a third leg 813 extending from the tool body 810. The third leg 813 is located between the first leg 811 and the second leg 812. The first leg 811 and the second leg 812 of the tool 800 may be received in the first receiving recess 191 and the second receiving recess 192, respectively, to enable the third leg 813 to be aligned with the third beam 183 of the overhanging component 180 in the vertical direction Z-Z and to bias the third beam 183 towards the bottom wall 178c, thereby moving the fourth beam 184 towards the bottom wall 178c to disengage from the bulge 582 of the insulative housing 500 of the electrical connector 20. As shown in FIG. 16D, by deflecting the tool away from the base portion (as schematically indicated by the arrow 51), the first leg 811 and the second leg 812 of the tool 800 can pry the accommodation portion 150 of the insulative housing 100 with the front edge 541a of the first wall 541 as a fulcrum, so as to move the accommodation portion 150 away from the accommodation portion 540 in the lateral direction X-X (as schematically indicated by the arrow 52). As shown in FIG. 16E, maintaining the first leg 811 and the second leg 812 in the first receiving recess 191 and the second receiving recess 192 and pulling the tool 800 away from the electrical connector 20 (as schematically indicated by the arrow 53) can cause the accommodation portion 150 to be moved out of the accommodation portion 540 in the lateral direction X-X (as schematically indicated by the arrow 54), so that the electrical connector 10 is un-mated from the electrical connector 20. Further, the third leg 813 of the tool 800 may be used to engage with the base body 401 of the latching member 400 to move the latching member 400 from the locked position to the pre-locked position. Such a configuration can facilitate operation of the electrical connector 10 in a space-constrained environment to un-mate the electrical connector 10 from the electrical connector 20.

The electrical connector 20′ can be mated with and un-mated from the electrical connector 10 in a similar manner. For the sake of brevity, details of these same portions will not be repeated herein.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear,” “upper,” “lower,” “left,” “right,” “transverse direction,” “vertical direction,” “perpendicular,” “horizontal,” “top,” “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on,” “above,” “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within +3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A plug connector for terminating first and second flexible cables comprising a connecting end having a plurality of conductive contacts facing the plurality of conductive contacts of other one of the first and second flexible cables, the plug connector comprising:
a housing having a front, rear, top, bottom, and two sides each joining the top and bottom and extending from the front to the rear, the housing comprising:
a top channel extending adjacent to the top and from the front through the rear, the top channel configured to receive the first flexible cable;
a bottom channel extending adjacent to the bottom and from the front, the bottom channel configured to receive the second flexible cable;
an accommodation space at the front, the accommodation space configured to receive portions of the first and second flexible cables having the plurality of conductive contacts; and
one or more latching features configured for holding the first and second flexible cables in the top and bottom channels.

2. The plug connector of claim 1, wherein the one or more latching features of the housing comprises:
a side channel extending from the bottom towards the top; and
a latching member comprising a first arm disposed in the side channel and configured to move between a pre-locked position when edges of the first and second flexible cables are offset from the first arm and a locked position when the edges of the first and second flexible cables engage the first arm such that the first and second flexible cables are fixedly disposed in the housing.

3. The plug connector of claim 2, wherein:
a side of the housing comprises a first slot and a second slot disposed closer to the top than the first slot; and
the latching member comprises a second arm comprising a bulge configured to be disposed in the first slot of the housing when the latching member is in the pre-locked position and in the second slot of the housing when the latching member is in the locked position.

4. The plug connector of claim 1, wherein:
the housing comprises a base portion, and an accommodation portion extending from the base portion and enclosing the accommodation space; and
each of the top and bottom channels comprises a portion extending at the base portion.

5. The plug connector of claim 4, in combination with the first and second flexible cables, wherein:
for each of the first and second flexible cables, the connecting end comprises a first segment disposed in the portion of a respective one of the top and bottom channels that extends at the base portion, and a second segment extending from the first segment and having the plurality of conductive contacts.

6. The plug connector of claim 5, wherein:
for each of the first and second flexible cables, the first segment comprises a notch aligned in the side channel of the housing;
the one or more latching features of the housing comprises:
a side channel extending from the bottom towards the top; and
a latching member comprising a first arm disposed in the side channel and configured to move between a pre-locked position when edges of the first and second flexible cables are offset from the first arm and a locked position when the edges of the first and second flexible cables engage the first arm such that the first and second flexible cables are fixedly disposed in the housing; and
at the locked position, the first arm of the latching member engages the notches of the first segments of the first and second flexible cables.

7. The plug connector of claim 5, wherein:
for each of the first and second flexible cables, the second segment comprises a notch; and
the one or more latching features of the housing comprises first and second beams extending from the base portion into the accommodation space, each of first and second beams comprising a protrusion configured to engage the notch of the second segment of a respective one of the first and second flexible cables.

8. The plug connector of claim 2, wherein:
the first arm comprises an upper portion, a lower portion, and a groove between the upper and lower portions;
at the pre-locked position, the upper portion of the first arm is disposed between the first and second flexible cables, and the lower portion of the first arm is disposed between the second flexible cable and the bottom of the housing; and
at the locked position, the upper and lower portions of the first arm engage the edges of the first and second flexible cables, respectively.

9. The plug connector of claim 4, wherein:
the top of the housing comprises a groove at the accommodation portion; and
the plug connector comprises:
an overhanging component having a proximal end connected to a bottom of the groove of the top at the accommodation portion and a distal end pointing to the rear, and
a connector position assurance device configured to engage the overhanging component, wherein:
the overhanging component comprises first and second beams extending between the proximal end and the distal end, and a third beam connecting the first and second beams at the distal end;
the top of the housing comprises a flange portion substantially aligned with the third beam of the overhanging component; and
the flange portion comprises first and second recesses towards the rear of the housing.

10. The plug connector of claim 1, wherein:
the first and second flexible cables comprise a flexible flat cable (FFC), and/or a flexible circuit board (FPC).

11. The plug connector of claim 1, wherein:
the front of the housing extends beyond front edges of the first and second flexible cables.

12. A receptacle connector comprising:
a housing comprising a base portion and a tongue portion extending from the base portion in a mating direction, the tongue portion comprising a top surface and a bottom surface opposite to the top surface in a vertical direction perpendicular to the mating direction; and
a plurality of conductive elements held by the housing, each of the plurality of conductive elements comprising a mating end extending into the tongue portion and having a mating contact portion, a tail end extending out of the housing, and an intermediate portion between the mating end and the tail end, the plurality of conductive elements comprising a plurality of first conductive elements having the mating contact portions protruding from the top surface of the tongue portion, and a plurality of second conductive elements having the mating contact portion protruding from the bottom surface of the tongue portion, wherein:
the tail end of each of the plurality of conductive elements comprises a first segment extending from the respective intermediate portion in the mating direction, a second segment configured to mount on a circuit board, and a third segment joining the first segment and the second segment;
the first segments of the tail ends of the plurality of first conductive elements and the tails ends of the plurality of second conductive elements are offset in the vertical direction; and
the second segments of the tail ends of the plurality of first conductive elements and the tails ends of the plurality of second conductive elements are offset in the mating direction.

13. The receptacle connector of claim 12, wherein:
the mating ends of the plurality of first conductive elements and the mating ends of the plurality of second conductive elements are offset in a longitudinal direction perpendicular to both the vertical direction and the mating direction.

14. The receptacle connector of claim 12, wherein:
the base portion of the housing comprises a plurality of protrusions extending from a rear surface of the base portion; and
the tail ends of the plurality of second conductive elements each extends out of a respective protrusion of the plurality of protrusions extending from the rear surface of the base portion of the housing.

15. The receptacle connector of claim 14, wherein:
the tail ends of the plurality of first conductive elements each extends out of the rear surface of the base portion of the housing between respective adjacent protrusions of the plurality of protrusions.

16. The receptacle connector of claim 12, wherein:
the mating end of each of the plurality of first conductive elements comprises first and second beams aligned in the vertical direction, the first beam extending beyond the second beam in the mating direction;
each of the first and second beams comprises a contact portion; and
the contact portions of the first and second beams are aligned in the mating direction.

17. The receptacle connector of claim 13, wherein:
the mating end of each of the plurality of conductive elements comprises first and second beams, the first beam extending beyond the second beam in the mating direction;
each of the first and second beams comprises a contact portion;
the contact portions of the first and second beams are aligned in the mating direction; and
the first beams of the plurality of conductive elements are disposed between respective second beams and the tongue portion of the housing.

18. The receptacle connector of claim 17, wherein, for each of the plurality of conductive elements, the contact portion of each of the first and second beams comprises:
a first end segment having a first width in the longitudinal direction;
a second end segment having a second width in the longitudinal direction, the second width less than the first width;
a first transition segment joining the first end segment and the second end segment;
a first leading surface adjacent a front end of the tongue portion and extending from the first end segment through the first transition segment to the second end segment; and
a first trailing surface away from the front of the tongue portion and extending from the first end segment through the first transition segment to the second end segment.

19. The receptacle connector of claim 18, wherein:
the housing comprises an accommodation portion extending from the base portion and enclosing an accommodation space open at an end opposite to the base portion; and
the tongue portion is disposed in the accommodation space.

20. An electronic system comprising:
the receptacle connector of claim 19; and
a plug connector configured to mate with the receptacle connector, the plug connector comprising:
a housing comprising a base portion and an accommodation portion extending from the base portion and enclosing an accommodation space, wherein the accommodation portion of the housing of the plug connector is configured to insert into the accommodation space of the receptacle connector such that the tongue portion of the receptacle connector is disposed in the accommodation space of the plug connector;
a first flexible cable held by the housing and comprising a plurality of contact pads configured to contact with the contact portions of the plurality of first conductive elements; and
a second flexible cable held by the housing and comprising a plurality of contact pads configured to contact with the contact portions of the plurality of second conductive elements.

21. The electronic system of claim 20, wherein:
the accommodation portion of the housing of the plug connector comprises an overhanging component;
the accommodation portion of the housing of the receptacle connector comprises a recess configured for receiving at least a portion of the overhanging component of the plug connector and a bulge configured for engaging the overhanging component of the plug connector;
the electronic system comprises a connector position assurance device configured for engaging both the overhanging component of the plug connector and the recess of the accommodation portion of the housing of the receptacle connector so as to secure the plug connector to the receptacle connector;
the housing of the plug connector comprises a flange portion configured to engage a front surface of the housing of the receptacle connector; and
the flange portion of the plug connector comprises a recess away from the front surface of the housing of the receptacle connector and configured for receiving a tool to unmate the plug connector from the receptacle connector.
